(19) United States
(12) Patent Application Publication
(10) Pub. No.: US 2025/0334603 A1
(43) Pub. Date: Oct. 30, 2025

(54) Methods, Devices, and Apparatus for Washing Samples by Exchanging Liquids

(71) Applicant: Curiox Biosystems Co., Ltd, Seoul (KR)

(72) Inventors: Namyong KIM, Vancouver (CA); Kok Siang TAN, Singapore (SG); Chyan Ying KE, Singapore (SG); Heejoun ROH, Seoul (KR); Kong Leong CHENG, Singapore (SG)

(21) Appl. No.: 18/829,279

(22) Filed: Sep. 9, 2024

Related U.S. Application Data
(60) Provisional application No. 63/639,715, filed on Apr. 29, 2024.

(51) Int. Cl. G01N 35/10

(52) U.S. Cl. CPC G01N 35/1016; G01N 35/1011; G01N 2035/1025

(57) ABSTRACT

An apparatus for washing a sample includes one or more liquid transferrers; one or more actuators; one or more processors; and memory storing one or more programs for execution by the one or more processors. The one or more programs include instructions for receiving information identifying a target residual volume; determining a final aspiration height based on the target residual volume; and sending a first set of one or more signals to an actuator to place a liquid transferrer at a first location corresponding to the final aspiration height.

### RELATED APPLICATIONS

This application claims the benefit of, and priority to, U.S. Provisional Patent Application Ser. No. 63/639,715, filed on Apr. 29, 2024, which is incorporated by reference herein in its entirety.

### TECHNICAL FIELD

This application relates generally to methods, devices, and apparatus for washing samples (e.g., cells, particles, etc.).

### BACKGROUND

Separation of biological cells is a critical task in many biological processes and assays. Conventional methods for separating biological cells include subjecting the biological cells in a liquid to a large acceleration, such as by using a centrifuge. The centrifugal force causes the biological cells to travel to the bottom of a tube and form a precipitate, allowing a remaining liquid called supernatant to be separated from the precipitate.

However, the mechanical force applied on the biological cells may affect the biological cells. For example, too much centrifugal force will cause lysis of biological cells.

### SUMMARY

Accordingly, there is need for methods, devices, and apparatus that allow separation of cells, which, in turn, is used for washing cells or other samples. Such methods, devices, and apparatus may replace the conventional methods, devices, and apparatus for washing samples. In addition, such methods, devices, and apparatus may reduce or eliminate the loss of cells during washing, thereby improving the reliability of cell-based reactions. Furthermore, such methods, devices, and apparatus may reduce or eliminate the loss of cell viability during washing, thereby increasing the yield in biological processes, such as cell-based assays or preparation of cells for cell therapy. Such methods, devices, and apparatus may also be used in washing other types of samples, such as beads or particles conjugated with target molecules.

A number of embodiments that overcome the limitations and disadvantages of existing methods, devices, and apparatus are presented in more detail below. These embodiments provide methods, devices, and apparatus for washing a sample in a solution.

As described in more detail below, in accordance with some embodiments, an apparatus for washing a sample includes one or more liquid transferrers; one or more actuators coupled with the one or more liquid transferrers; one or more processors in communication with the one or more actuators; and memory storing one or more programs for execution by the one or more processors. The one or more programs include instructions for: positioning, with at least a first subset of the one or more actuators, at least a first subset of the one or more liquid transferrers at a first height for dispensing liquid into a sample solution while a nozzle of at least the first subset of the one or more liquid transferrers is in contact with the sample solution; and positioning, with at least a second subset of the one or more actuators, at least a second subset of the one or more liquid transferrers at a second height for aspirating liquid from the sample solution.

In accordance with some embodiments, a method is performed by an apparatus that includes one or more liquid transferrers and one or more actuators coupled with the one or more liquid transferrers for washing a sample. The method includes positioning, with at least a first subset of the one or more actuators, at least a first subset of the one or more liquid transferrers at a first height for dispensing liquid into a sample solution while a nozzle of at least the first subset of the one or more liquid transferrers is in contact with the sample solution; and positioning, with at least a second subset of the one or more actuators, at least a second subset of the one or more liquid transferrers at a second height for aspirating liquid from the sample solution.

In some embodiments, a computer readable storage medium stores one or more programs for execution by one or more processors of an apparatus with one or more liquid transferrers and one or more actuators coupled with the one or more liquid transferrers. The one or more programs include instructions for: positioning, with at least a first subset of the one or more actuators, at least a first subset of the one or more liquid transferrers at a first height for dispensing liquid into a sample solution while a nozzle of at least the first subset of the one or more liquid transferrers is in contact with the sample solution; and positioning, with at least a second subset of the one or more actuators, at least a second subset of the one or more liquid transferrers at a second height for aspirating liquid from the sample solution.

In accordance with some embodiments, an apparatus for washing a sample includes one or more liquid transferrers; one or more actuators coupled with the one or more liquid transferrers; one or more processors in communication with the one or more actuators; and memory storing one or more programs for execution by the one or more processors. The one or more programs include instructions for: positioning at least one liquid transferrer of the one or more liquid transferrers at a first height for dispensing liquid into a sample solution while a nozzle of the at least one liquid transferrer is in contact with the sample solution; and positioning at least one liquid transferrer of the one or more liquid transferrers at a second height for aspirating liquid from the sample solution.

In accordance with some embodiments, a method is performed by an apparatus that includes one or more liquid transferrers and one or more actuators coupled with the one or more liquid transferrers for washing a sample. The method includes positioning at least one liquid transferrer of the one or more liquid transferrers at a first height for dispensing liquid into a sample solution while a nozzle of the at least one liquid transferrer is in contact with the sample solution; and positioning at least one liquid transferrer of the one or more liquid transferrers at a second height for aspirating liquid from the sample solution.

In accordance with some embodiments, a computer readable storage medium stores one or more programs for execution by an apparatus with one or more liquid transferrers and one or more actuators coupled with the one or more liquid transferrers. The one or more programs include instructions for: positioning at least one liquid transferrer of the one or more liquid transferrers at a first height for dispensing liquid into a sample solution while a nozzle of the at least one liquid transferrer is in contact with the sample solution; and positioning at least one liquid transferrer of the one or more liquid transferrers at a second height for aspirating liquid from the sample solution.

In accordance with some embodiments, a computer readable storage medium stores one or more programs for execution by one or more processors of an electronic device in communication with an aspirator actuator and an aspirator coupled with the aspirator actuator. The one or more programs include instructions for: sending a first set of one or more signals to the aspirator actuator to place the aspirator at a first location relative to a first well; and sending a second set of one or more signals to the aspirator to cause the aspirator to aspirate liquid in the first well.

In accordance with some embodiments, a computer readable storage medium storing one or more programs for execution by one or more processors of an electronic device in communication with a dispenser actuator and a dispenser coupled with the dispenser actuator. The one or more programs include instructions for: sending a first set of one or more signals to the dispenser actuator to place the dispenser at a first location relative to a first well; and sending a second set of one or more signals to the dispenser to cause the dispenser to dispense a wash liquid in the first well.

In accordance with some embodiments, an electronic device in communication with a dispenser actuator and a dispenser coupled with the dispenser actuator includes one or more processors; and any computer readable storage medium described herein.

In accordance with some embodiments, an apparatus includes a dispenser actuator; a dispenser; and any electronic device described herein.

In accordance with some embodiments, a computer readable storage medium stores one or more programs for execution by one or more processors of an electronic device in communication with an aspirator actuator coupled with an aspirator. The one or more programs include instructions for: receiving information identifying a target residual volume; determining a final height based on the target residual volume; and sending a first set of one or more signals to the aspirator actuator to place the aspirator at a first location.

In accordance with some embodiments, a method is performed by an electronic device in communication with an aspirator actuator coupled with an aspirator. The method includes receiving information identifying a target residual volume; determining a final height based on the target residual volume; and sending a first set of one or more signals to the aspirator actuator to place the aspirator at a first location.

In accordance with some embodiments, an electronic device in communication with an aspirator actuator coupled with an aspirator includes one or more processors; and memory storing one or more programs for execution by the one or more processors. The one or more programs include instructions for: receiving information identifying a target residual volume; determining a final height based on the target residual volume; and sending a first set of one or more signals to the aspirator actuator to place the aspirator at a first location.

In accordance with some embodiments, a device includes a block defining a plurality of through-holes, wherein a respective through-hole of the plurality of through-holes is configured to fit with an outside of a pipette tip.

In accordance with some embodiments, a block defines a plurality of through-holes, wherein a respective through-hole of the plurality of through-holes is configured to fit with an outside of a pipette tip.

In accordance with some embodiments, a pipette tip includes a tube having a first end portion and a second end portion opposite to the first end portion. The first end portion is characterized by a first inner diameter and the second end portion is characterized by a second inner diameter less than the first inner diameter. The second end portion includes a first region located at a tip of the second end portion and a second region located away from the tip of the second end portion. The first region is characterized by the second inner diameter and the second region is characterized by a third inner diameter less than the second inner diameter.

In accordance with some embodiments, a pipette tip includes a tube having a first end portion and a second end portion opposite to the first end portion. The first end portion is characterized by a first inner diameter and the second end portion is characterized by a second inner diameter less than the first inner diameter. A tip of the second end portion is enclosed along a direction of the tube. The second end portion defines one or more side holes.

In accordance with some embodiments, a device includes a liquid transferrer; and one or more actuators coupled with the liquid transferrer for moving the liquid transferrer in a non-vertical direction while the liquid transferrer dispenses or aspirates liquid.

In accordance with some embodiments, a method performed by an electronic device in communication with one or more actuators coupled with a liquid transferrer. The method includes moving the liquid transferrer in a non-vertical direction while the liquid transferrer dispenses or aspirates liquid.

In accordance with some embodiments, a system for automated sample washing by liquid exchange includes one or more liquid transferrers; an actuator coupled with the one or more liquid transferrers; one or more processors; and memory storing one or more programs for execution by the one or more processors. The one or more programs include instructions for: sending a first set of instructions to the actuator for aspirating liquid in a liquid container and dispensing the aspirated liquid outside the liquid container; and sending a second set of instructions to the actuator for aspirating a wash solution and dispensing the wash solution into the liquid container, thereby washing a sample without using centrifugation.

In accordance with some embodiments, a method is performed by a system that includes one or more liquid transferrers and an actuator coupled with the one or more liquid transferrers. The method includes sending a first set of instructions to the actuator for aspirating liquid in a liquid container and dispensing the aspirated liquid outside the liquid container; and sending a second set of instructions to the actuator for aspirating a wash solution and dispensing the wash solution into the liquid container, thereby washing a sample without using centrifugation.

In accordance with some embodiments, a computer readable storage medium stores one or more programs for execution by one or more processors in communication with an actuator coupled with one or more liquid transferrers. The one or more programs include instructions for: sending a first set of instructions to the actuator for aspirating liquid in a liquid container and dispensing the aspirated liquid outside the liquid container; and sending a second set of instructions to the actuator for aspirating a wash solution and dispensing the wash solution into the liquid container, thereby washing a sample without using centrifugation.

In accordance with some embodiments, an electronic device in communication with a robotic system including a liquid transferrer includes one or more processors; and memory storing one or more programs for execution by the one or more processors. The one or more programs include instructions for: receiving information identifying one or more parameters for an incubation operation, the one or more parameters for the incubation operation including an incubation time; receiving information identifying one or more parameters for a washing operation; sending a first set of instructions to the robotic system to cause the robotic system to incubate a plate in accordance with the one or more parameters for the incubation operation; and subsequent to sending the first set of instructions, sending a second set of instructions to the robotic system to cause the robotic system to dispense and aspirate liquid in accordance with the one or more parameters for the washing operation. In some embodiments, the robotic system includes a temperature controller. In some embodiments, the robotic system includes a tilter.

In accordance with some embodiments, a method is performed by an electronic device in communication with a robotic system including a liquid transferrer. The method includes receiving information identifying one or more parameters for an incubation operation, the one or more parameters for the incubation operation including an incubation time; receiving information identifying one or more parameters for a washing operation; sending a first set of instructions to the robotic system to cause the robotic system to incubate a plate in accordance with the one or more parameters for the incubation operation; and subsequent to sending the first set of instructions, sending a second set of instructions to the robotic system to cause the robotic system to dispense and aspirate liquid in accordance with the one or more parameters for the washing operation. In some embodiments, the robotic system includes a temperature controller. In some embodiments, the robotic system includes a tilter.

In accordance with some embodiments, a computer readable storage medium stores one or more programs for execution by one or more processors in communication with a robotic system including a liquid transferrer. The one or more programs include instructions for: receiving information identifying one or more parameters for an incubation operation, the one or more parameters for the incubation operation including an incubation time; receiving information identifying one or more parameters for a washing operation; sending a first set of instructions to the robotic system to cause the robotic system to incubate a plate in accordance with the one or more parameters for the incubation operation; and subsequent to sending the first set of instructions, sending a second set of instructions to the robotic system to cause the robotic system to dispense and aspirate liquid in accordance with the one or more parameters for the washing operation. In some embodiments, the robotic system includes a temperature controller. In some embodiments, the robotic system includes a tilter.

In accordance with some embodiments, a computer readable storage medium stores one or more programs for execution by one or more processors of an electronic device in communication with an aspirator actuator coupled with an aspirator. The one or more programs including instructions for: receiving information identifying a target residual volume; determining a final aspiration height based on the target residual volume; and sending a first set of one or more signals to the aspirator actuator to place the aspirator at a first location corresponding to the final aspiration height.

In accordance with some embodiments, a computer readable storage medium stores one or more programs for execution by one or more processors of an electronic device in communication with a dispenser actuator coupled with a dispenser. The one or more programs include instructions for: receiving information identifying a target residual volume; determining a first dispensing height based on the target residual volume; and sending a first set of one or more signals to the dispenser actuator to place the dispenser at a first location corresponding to the first dispensing height.

In accordance with some embodiments, a computer readable storage medium stores one or more programs for execution by one or more processors of an electronic device in communication with a liquid transferrer actuator coupled with a liquid transferrer. The one or more programs include instructions for: receiving information identifying a target residual volume; determining a final aspiration height based on the target residual volume; and sending a first set of one or more signals to the liquid transferrer actuator to place the liquid transferrer at a first location corresponding to the final aspiration height.

In accordance with some embodiments, a computer readable storage medium stores one or more programs for execution by one or more processors in communication with an actuator coupled with one or more liquid transferrers. The one or more programs include instructions for: sending to the actuator a first set of one or more instructions for aspirating liquid in a liquid container and dispensing the aspirated liquid outside the liquid container; sending to the actuator a second set of one or more instructions for aspirating a wash solution and dispensing the wash solution into the liquid container; and repeating sending of the first set of one or more instructions and the second set of one or more instructions, thereby washing a sample regardless of use of centrifugation.

In accordance with some embodiments, a computer readable storage medium stores one or more programs for execution by one or more processors in communication with a robotic system including a liquid transferrer. The one or more programs include instructions for: receiving information identifying one or more parameters for an incubation operation, the one or more parameters for the incubation operation including an incubation time; receiving information identifying one or more parameters for a washing operation; causing the robotic system to incubate a solution in a liquid container in accordance with the one or more parameters for the incubation operation; and subsequent to causing the robotic system to incubate the solution in the liquid container, sending a first set of one or more instructions to the robotic system to cause the robotic system to dispense, with the liquid transferrer, liquid into the liquid container and aspirate liquid from the liquid container in accordance with the one or more parameters for the washing operation.

In accordance with some embodiments, a computer readable storage medium stores one or more programs for execution by one or more processors of an apparatus with one or more liquid transferrers and one or more actuators coupled with the one or more liquid transferrers, the one or more programs including instructions for: positioning, with at least a first subset of the one or more actuators, at least a first subset of the one or more liquid transferrers at a first height for dispensing liquid into the sample solution while a nozzle of at least the first subset of the one or more liquid transferrers is in contact with the sample solution; and positioning, with at least a second subset of the one or more actuators, at least a second subset of the one or more liquid transferrers at a second height for aspirating liquid from the sample solution.

### BRIEF DESCRIPTION OF THE DRAWINGS

For a better understanding of the aforementioned embodiments as well as additional embodiments, reference should be made to the Description of Embodiments below, in conjunction with the following drawings in which like reference numerals refer to corresponding parts throughout the figures.

FIG. 1 is a perspective view of a plate in accordance with some embodiments.

FIG. 2 is a cross-sectional view of the plate shown in FIG. 1.

FIG. 3 is a schematic diagram illustrating a liquid handling system in accordance with some embodiments.

FIG. 4 is a schematic diagram illustrating electronic components of a liquid handling system in accordance with some embodiments.

FIGS. 5A-5C are schematic diagrams illustrating an aspiration operation in accordance with some embodiments.

FIGS. 6A-6D illustrate example height profiles during an aspiration operation in accordance with some embodiments.

FIGS. 7A-7C are schematic diagrams illustrating a dispensing operation in accordance with some embodiments.

FIGS. 8A-8D illustrate example height profiles during a dispensing operation in accordance with some embodiments.

FIG. 9 is a schematic diagram illustrating a liquid exchange apparatus in accordance with some embodiments.

FIG. 10 shows experimental results for particle retention in accordance with some embodiments.

FIG. 11 is a schematic diagram illustrating a data structure for operation of a liquid handling system in accordance with some embodiments.

FIG. 12 is a schematic diagram illustrating a lookup table for liquid exchange operations in accordance with some embodiments.

FIGS. 13A-13M illustrate an apparatus with a tilting device for separating biological cells in accordance with some embodiments.

FIGS. 14A-14C illustrate a device for aligning pipette tips in accordance with some embodiments.

FIGS. 15A-15C illustrate a device for aligning pipette tips in accordance with some embodiments.

FIGS. 16A-16C illustrate a device for aligning pipette tips in accordance with some embodiments.

FIGS. 17A-17C illustrate a device for aligning pipette tips in accordance with some embodiments.

FIGS. 18A and 18B illustrate a pipette tip in accordance with some embodiments.

FIGS. 19A and 19B illustrate a pipette tip in accordance with some embodiments.

FIG. 20A illustrates an apparatus with an actuator for rotating a pipette tip on-axis in accordance with some embodiments.

FIG. 20B illustrates an apparatus with an actuator for rotating a pipette tip off-axis in accordance with some embodiments.

FIG. 20C illustrates an apparatus with an actuator for moving a pipette tip laterally in accordance with some embodiments.

FIG. 21 is a flow diagram illustrating a method of determining a height of an aspirator based on a volume in accordance with some embodiments.

FIG. 22 is a flow diagram illustrating a method of determining a height of a dispenser based on a volume in accordance with some embodiments.

FIG. 23 is a flow diagram illustrating a method of moving a liquid transferrer in a non-vertical direction in accordance with some embodiments.

FIG. 24 is a flow diagram illustrating a method of controlling an actuator for washing a sample without using centrifugation in accordance with some embodiments.

FIG. 25 is a flow diagram illustrating a method of controlling a robotic system for washing operation in accordance with some embodiments.

FIG. 26 is a flow diagram illustrating a method of washing a sample without using centrifugation in accordance with some embodiments.

FIG. 27 is a flow diagram illustrating a method of aspirating liquid in accordance with some embodiments.

FIG. 28 is a flow diagram illustrating a method of dispensing liquid in accordance with some embodiments.

FIG. 29A illustrates a graphical user interface for receiving parameters for an incubation operation in accordance with some embodiments.

FIG. 29B illustrates a data structure for determining a liquid height in accordance with some embodiments.

FIGS. 30A and 30B are flow diagrams illustrating operations carried out by one or more processors of an electronic device for operating an aspirator in accordance with some embodiments.

FIG. 31 is a flow diagram illustrating operations carried out by one or more processors of an electronic device for operating a dispenser in accordance with some embodiments.

FIG. 32 is a flow diagram illustrating operations carried out by one or more processors of an electronic device for operating a liquid transferrer in accordance with some embodiments.

FIG. 33 is a flow diagram illustrating operations carried out by one or more processors for washing a sample in accordance with some embodiments.

FIG. 34 is a flow diagram illustrating operations carried out by one or more processors for incubating a solution in accordance with some embodiments.

FIG. 35 is a flow diagram illustrating operations carried out by one or more processors for washing a sample in accordance with some embodiments.

Like reference numerals refer to corresponding parts throughout the drawings.

Drawings are not necessarily drawn to scale unless indicated otherwise.

### DESCRIPTION OF EMBODIMENTS

Methods, devices, and apparatus for washing samples are described. Reference will be made to certain embodiments, examples of which are illustrated in the accompanying drawings. While the claims will be described in conjunction with the embodiments, it will be understood that it is not intended to limit the claims to these particular embodiments alone. On the contrary, the embodiments are intended to cover alternatives, modifications and equivalents that are within the spirit and scope of the appended claims.

Moreover, in the following description, numerous specific details are set forth to provide a thorough understanding of the embodiments. However, it will be apparent to one of ordinary skill in the art that the embodiments may be practiced without these particular details. In other instances, methods, procedures, components, and networks that are well-known to those of ordinary skill in the art are not described in detail to avoid obscuring aspects of the embodiments.

It will also be understood that, although the terms first, second, etc. may be used herein to describe various elements, these elements should not be limited by these terms. These terms are only used to distinguish one element from another. For example, a first dispenser could be termed a second dispenser, and, similarly, a second dispenser could be termed a first dispenser, without departing from the scope of the embodiments. The first dispenser and the second dispenser are both dispensers, but they are not the same dispenser. Similarly, a first aspirator could be termed a second aspirator, and, similarly, a second aspirator could be termed a first aspirator, without departing from the scope of the embodiments. The first aspirator and the second aspirator are both aspirators, but they are not the same aspirator.

The terminology used in the description of the embodiments herein is for the purpose of describing particular embodiments only and is not intended to be limiting of the invention. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

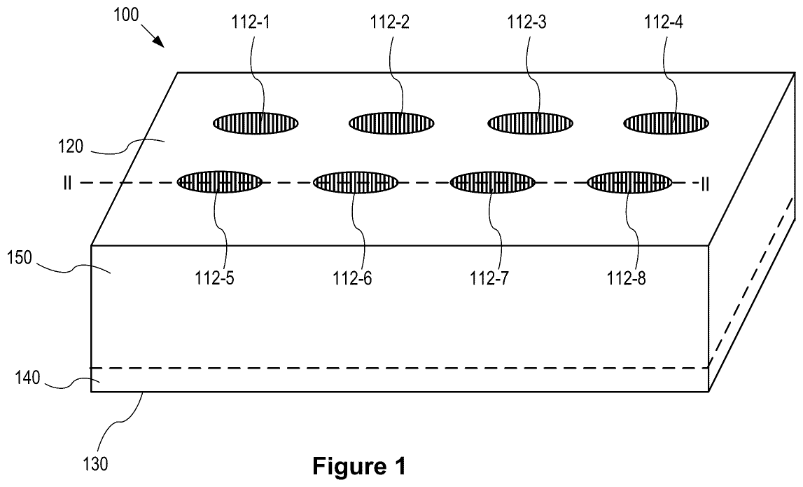

FIG. 1 is a perspective view of a plate 100 in accordance with some embodiments. The plate 100 has a top surface 120 and a bottom surface 130 opposite to the top surface 120. A plurality of wells 112 (e.g., wells 112-1 through 112-8) is defined in the plate 100. The plate 100 includes a first portion 140 that corresponds to a bottom of the plurality of wells 112 and a second portion 150 that corresponds to one or more walls of the plurality of wells 112. In some embodiments, the plate 100 is formed integrally. In some embodiments, the plate 100 is formed by attaching two or more portions together (e.g., by bonding separately formed first and second portions 140 and 150). In some embodiments, as shown in FIG. 1, the plurality of wells 112 is arranged in an array (e.g., 2-by-3 array, 2-by-4 array, 3-by-4 array, 4-by-6 array, 6-by-8 array, 8-by-12 array, 16-by-24 array, 32-by-48 array, etc.). In some embodiments, a respective well 112 is a cylindrical well (e.g., a cross-section of the respective well 112 along a plane substantially parallel to the plate 100 has a shape of a circle).

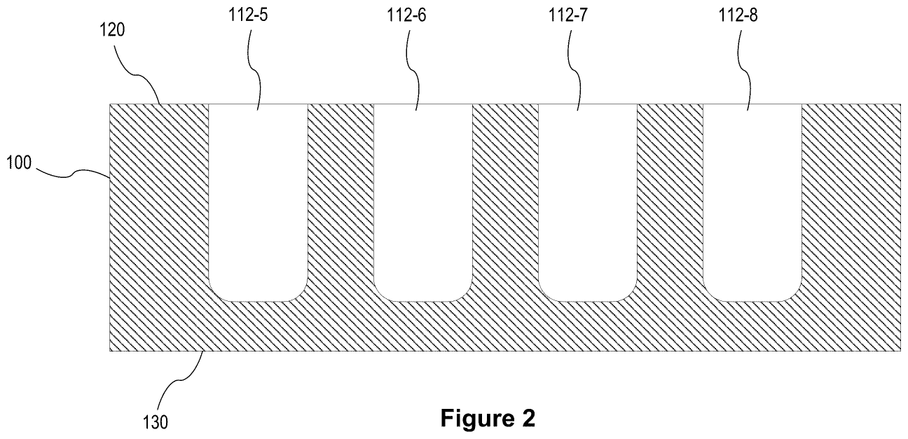

FIG. 2 is a cross-sectional view of the plate 100 shown in FIG. 1. In some embodiments, a respective well 112 has a width of 2 mm-170 mm (e.g., 2 mm, 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, or any interval between two of the aforementioned values, such as 5 mm-8 mm). In some embodiments, the respective well 112 has a height of 2 mm-170 mm (e.g., 2 mm, 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, or any interval between two of the aforementioned values, such as 3 mm-70 mm).

Although FIG. 2 illustrates a particular shape for the respective well 112, the bottom of the respective well 112 may have any other shape. For example, in some embodiments, the respective well 112 has a round bottom. In some embodiments, the respective well 112 has a V-shaped bottom. In some embodiments, the respective well 112 has a flat bottom. In some embodiments, a respective corner of the respective well 112 is rounded (e.g., even for a well with a flat bottom or a V-shaped bottom, one or more corners are rounded). In some configurations, it has been observed that a liquid container with a rounded corner works better than a liquid container without a rounded corner (e.g., a liquid container with an angular or sharp corner) for liquid exchange. Without limiting the scope of claims, this may be due to the fact that presence of an angular or sharp corner could a dead zone causing less efficient liquid exchange, leading to less dilution of the existing solution or reagent. In some embodiments, the rounded corner is characterized by a radius of curvature (or an R value) of 0.1 mm or greater. In some embodiments, the rounded corner is characterized by the radius of curvature (or the R value) greater than 0.1 mm. In some embodiments, the rounded corner is characterized by the radius of curvature (or the R value) of 1 mm or greater. In some embodiments, the rounded corner is characterized by the radius of curvature (or the R value) greater than 1 mm.

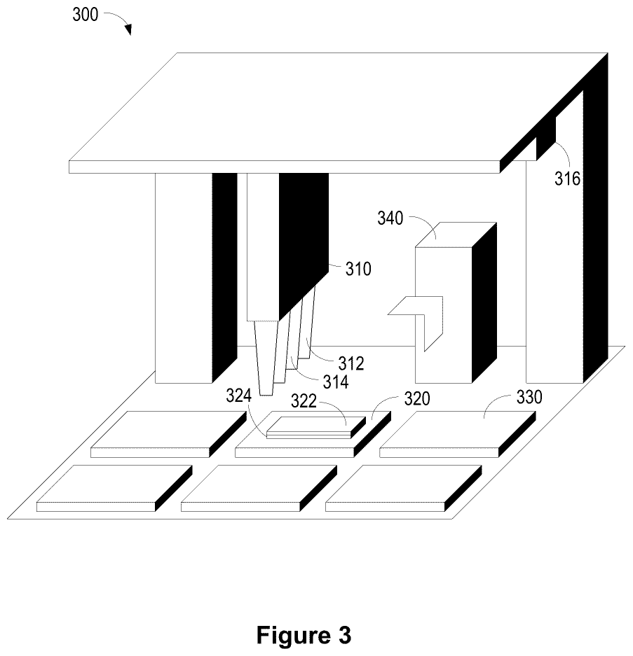

FIG. 3 is a schematic diagram illustrating a liquid handling system 300 in accordance with some embodiments.

The liquid handling system 300 (also called a liquid handler, a liquid handling robot, or a liquid handling workstation) is used for automatically (or robotically) transferring, aliquoting, and/or mixing liquid samples.

The liquid handling system 300 includes one or more liquid transferrers 312 and 314 (e.g., pipettes). The one or more liquid transferrers 312 and 314 are mechanically coupled to (e.g., mounted on) an actuator 310 (e.g., a vertical actuator). The actuator 310 moves the one or more liquid transferrers in one or more directions (e.g., a vertical direction). In some embodiments, the actuator 310 moves each liquid transferrer independently (e.g., moving the liquid transferrer 312 independently from the position and/or movement of the liquid transferrer 314 and moving the liquid transferrer 314 independently from the position and/or movement of the liquid transferrer 312). In some embodiments, the actuator 310 moves the liquid transferrers 312 and 314 together (e.g., concurrently in a same direction by a same distance at a same speed). In some embodiments, the one or more liquid transferrers are mechanically coupled to (directly or indirectly) to two or more actuators (e.g., actuators 310 and 316). In some embodiments, each actuator of the two or more actuators is configured to move the one or more liquid transferrers along a respective axis (e.g., the actuator 310 moves the one or more liquid transferrers along a first axis, such as a vertical axis, and the actuator 316 moves the one or more liquid transferrers along a second axis non-parallel to the first axis, such as a horizontal axis). For example, the actuators 310 and 316 may provide movement of the one or more liquid transferrers in X and Z directions. In some embodiments, the two or more actuators include (or constitute) a three-dimensional actuator capable of moving or positioning the one or more actuators in a three-dimensional space (e.g., capable of moving the one or more actuators along X, Y, and Z axes).

The liquid handling system 300 also includes one or more decks (e.g., decks 320 and 330) for placement of a liquid container (e.g., the plate 100 described with respect to FIGS. 1 and 2 or one or more tubes) and other materials. For example, in some embodiments, the liquid handling system 300 includes one or more decks for:
pipette tips; and
containers (e.g., reservoirs) for holding reagents or waste solutions.

In some embodiments, one or more decks (e.g., deck 320) include a temperature controller 322. In some embodiments, the temperature controller 322 adjusts the temperature of incubation (e.g., in the range of −20-100° C.). In some embodiments, the temperature controller 322 controls a temperature of a liquid container and/or liquid contained therein (e.g., incubation). In some embodiments, the temperature controller 322 is capable of adjusting the temperature of the liquid container and/or liquid contained therein (e.g., in the range of −20-100° C.). In some embodiments, the temperature controller 322 includes, or is, a heater.

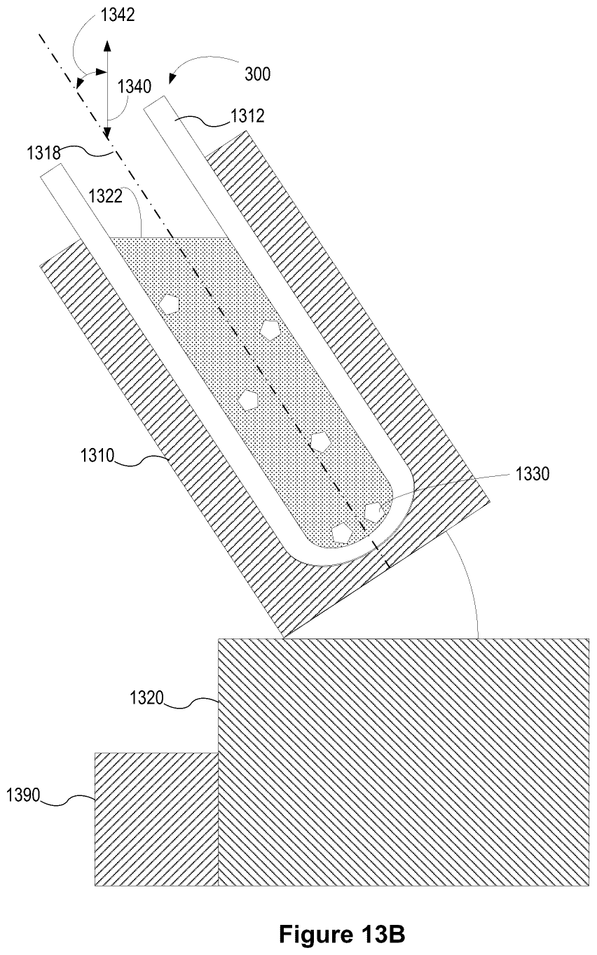

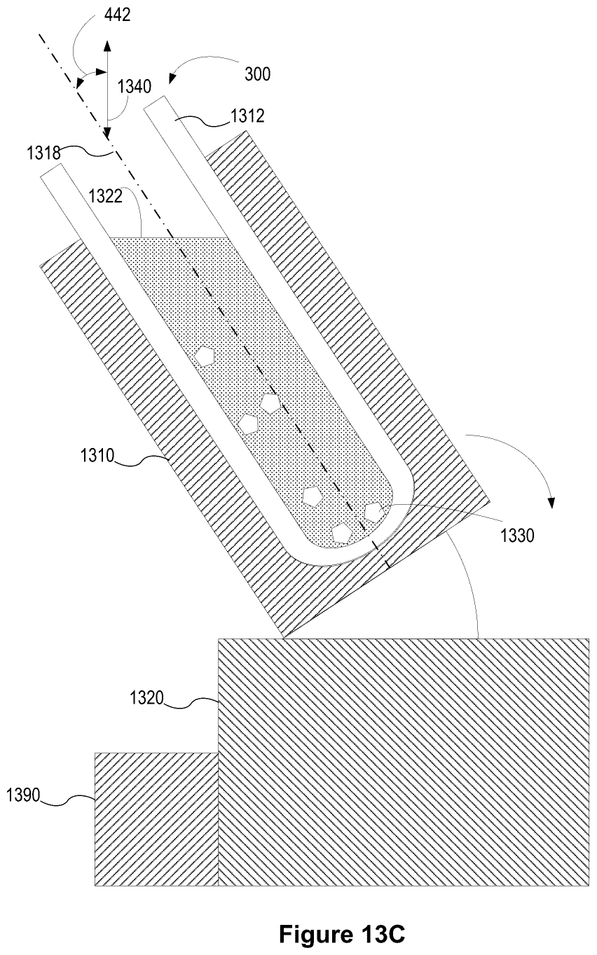

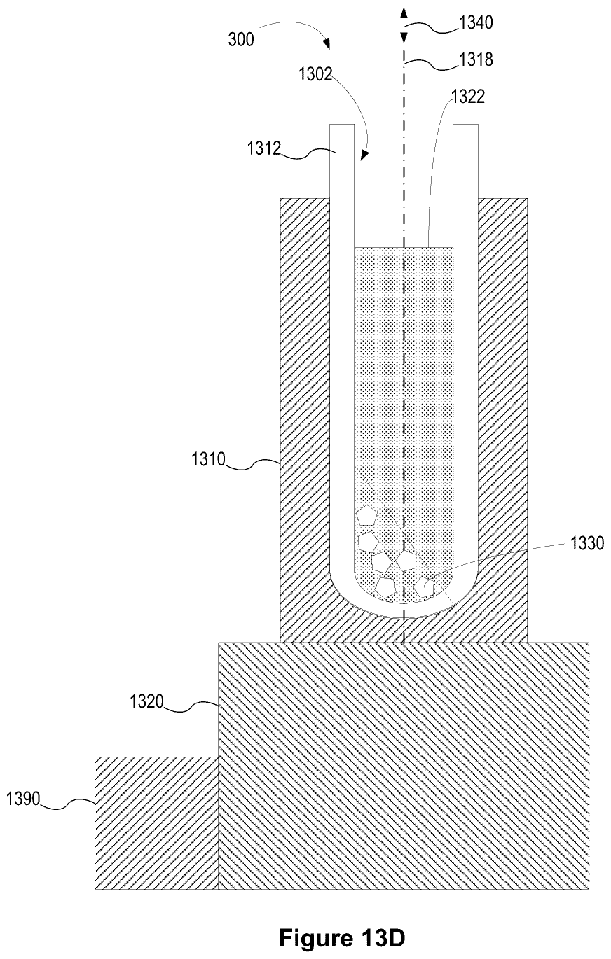

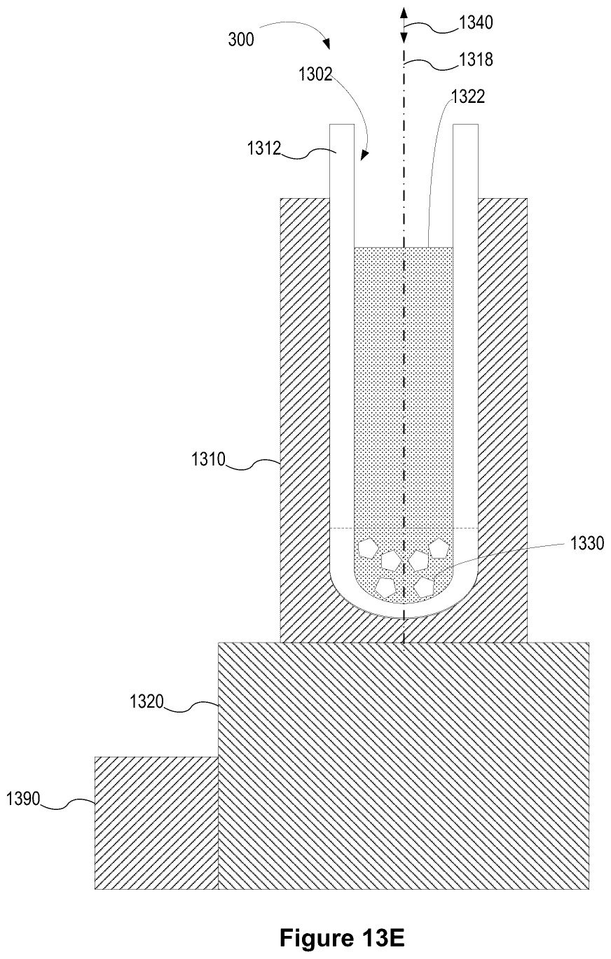

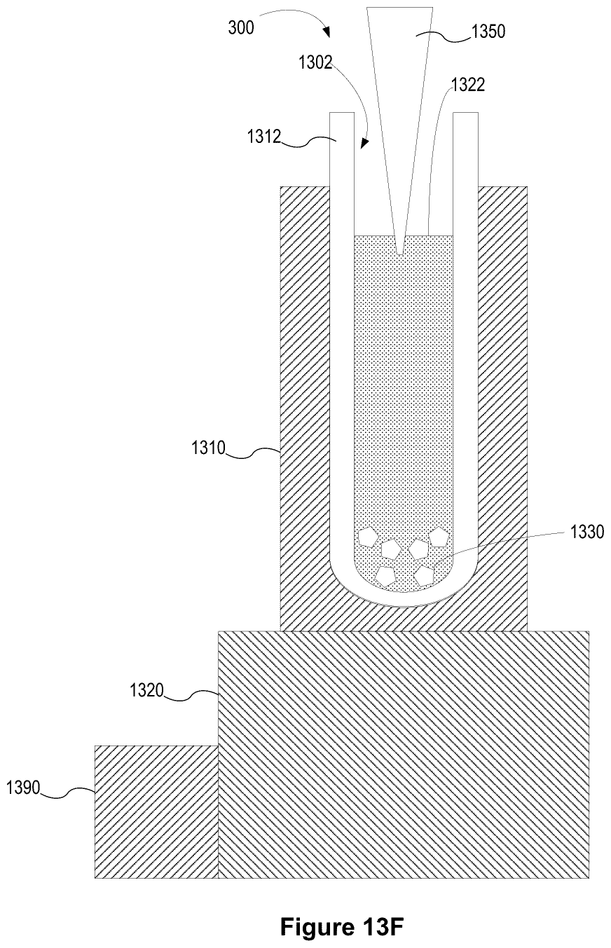

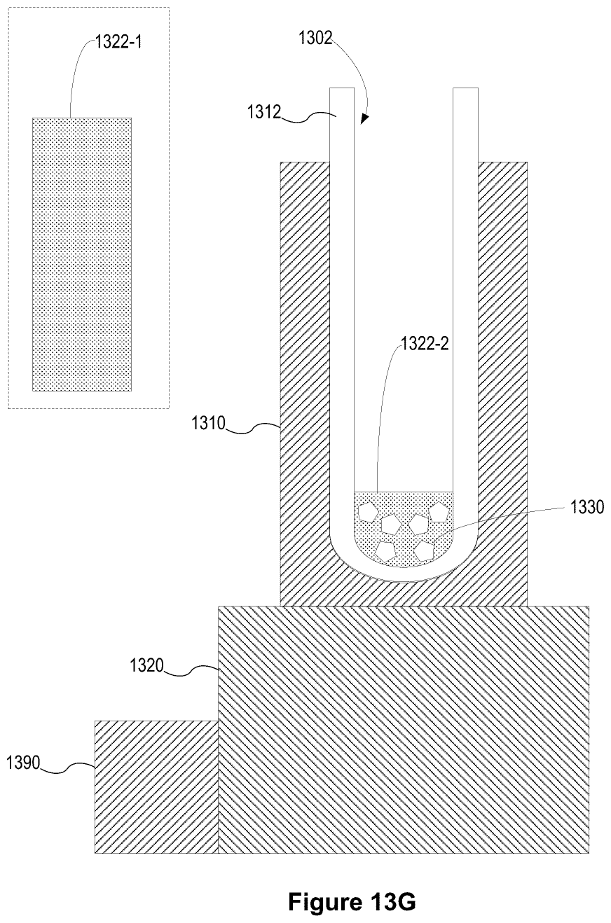

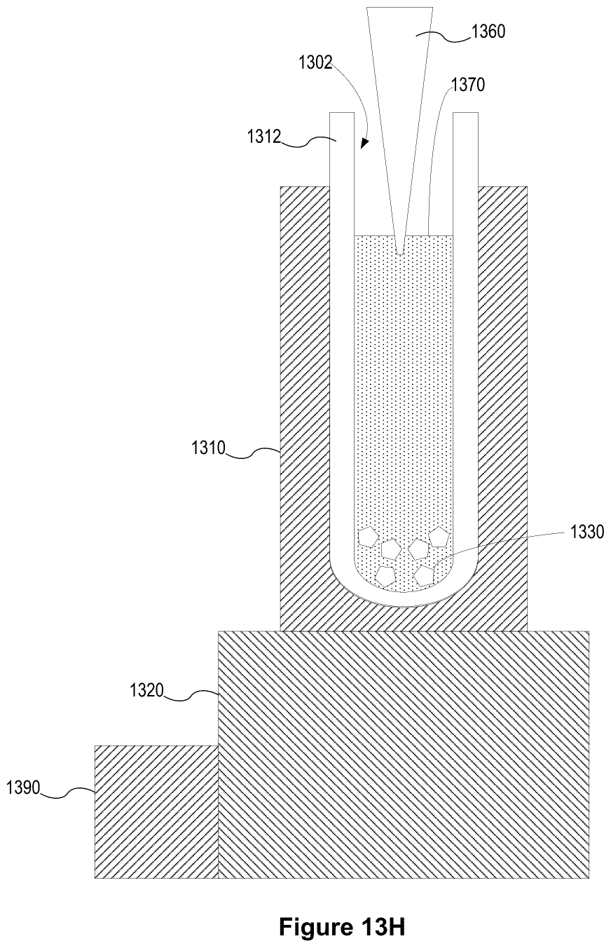

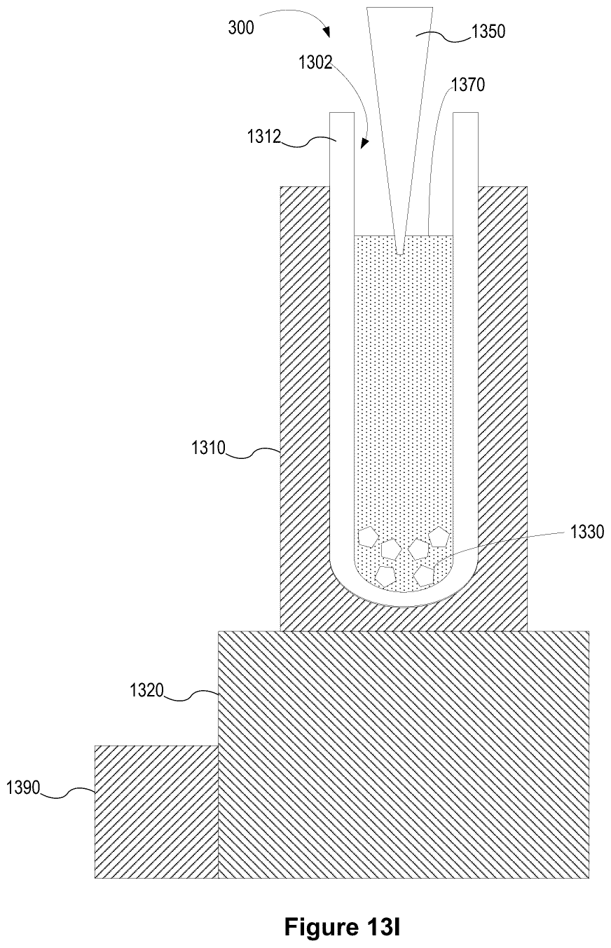

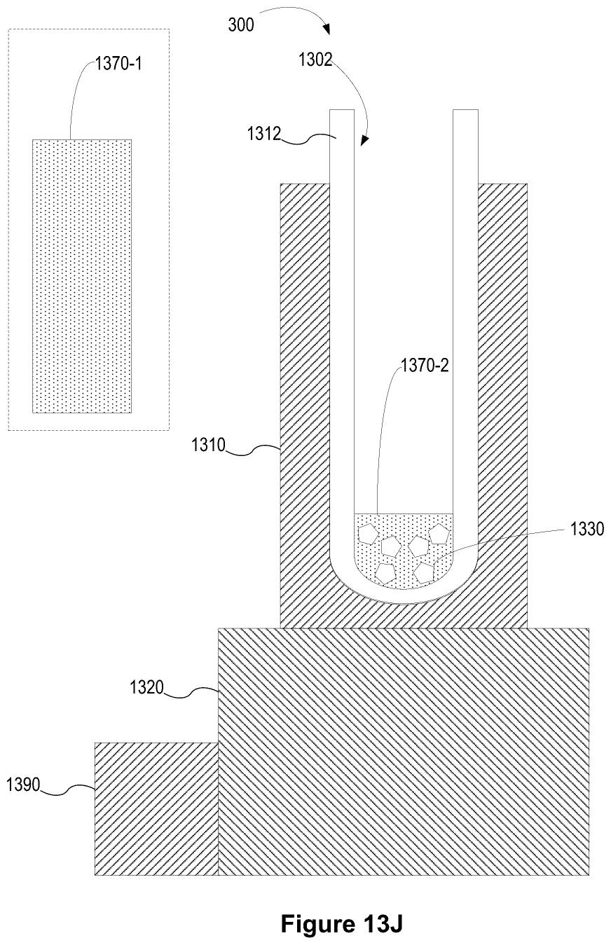

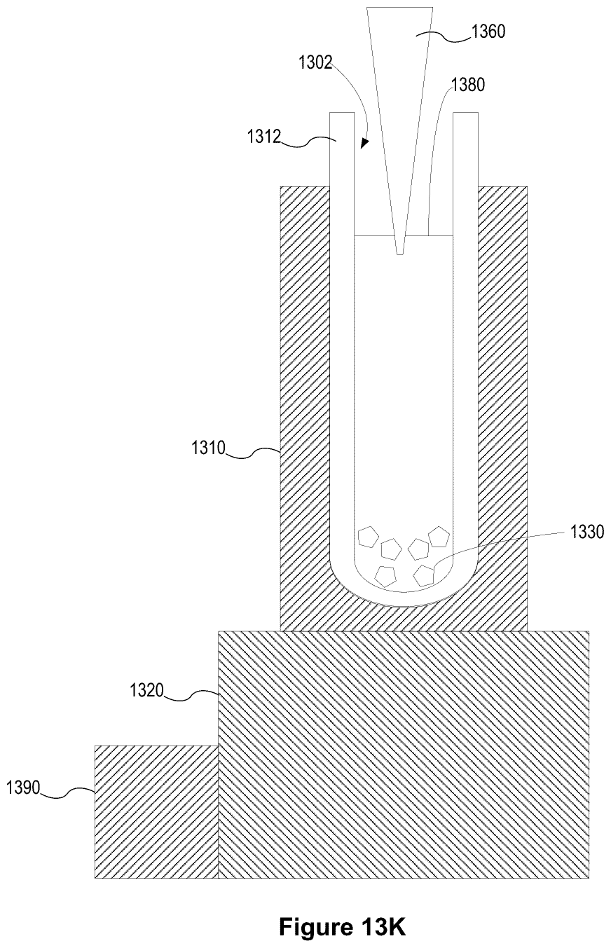

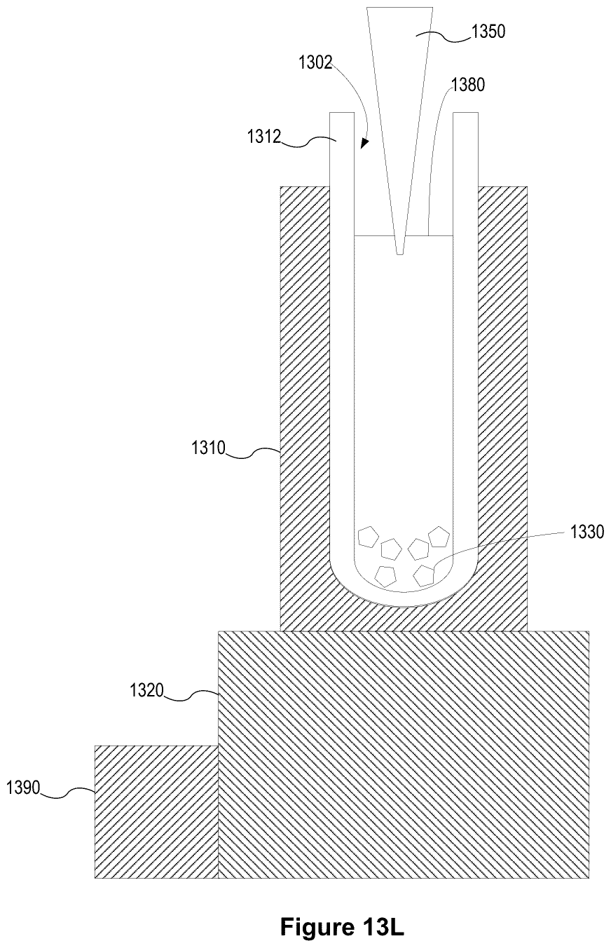

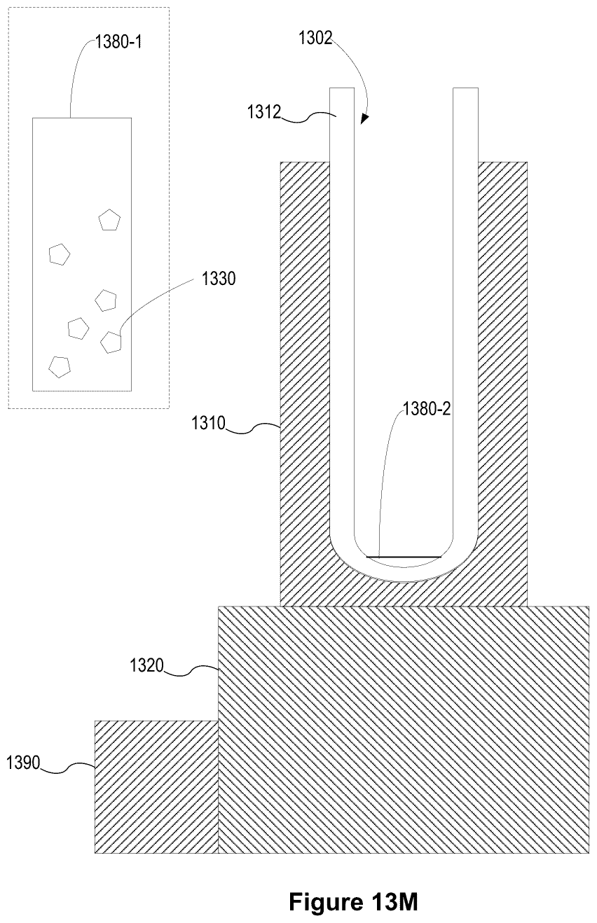

In some embodiments, one or more decks (e.g., deck 320) include a tilting device 324 (described further with respect to FIGS. 13A-13M). In some embodiments, the tilting device 324 moves the liquid container between a non-tilted position and a tilted position.

In some embodiments, one or more decks (e.g., deck 320) include a shaking or vibration device. In some embodiments, the shaking or vibration device moves the liquid container in one, two, or three dimensional motions. In some embodiments, the shaking or vibration device is coupled with, or integrated with, the tilting device 324 as described with respect to FIGS. 13A-13M.

In some embodiments, the liquid handling system 300 includes a robotic arm 340. In some embodiments, the robotic arm 340 is configured to move one or more plates within the liquid handling system 300 (e.g., between two decks). In some embodiments, the robotic arm 340 (also called a plate handler) is configured to move one or more plates within the liquid handling system 300 (e.g., between two decks).

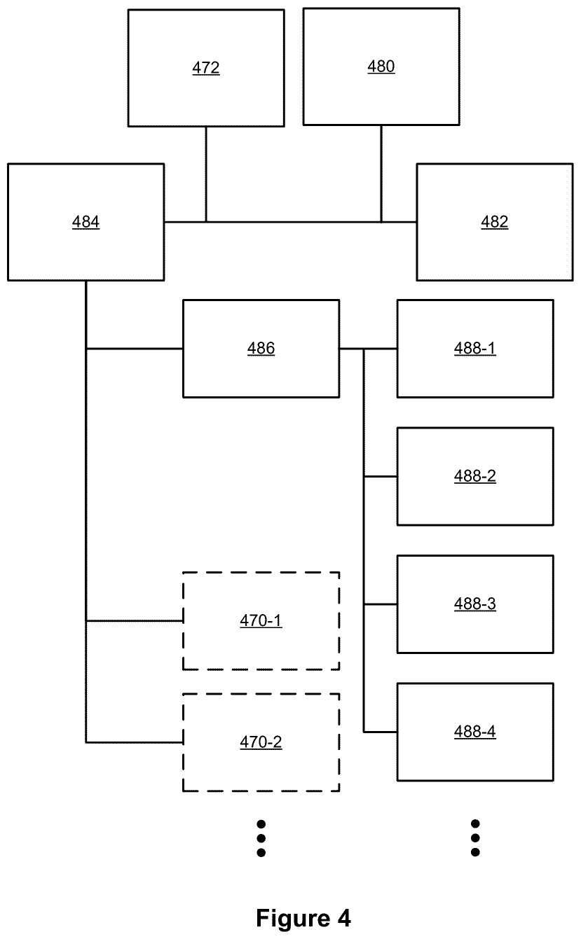

FIG. 4 is a schematic diagram illustrating electronic components of a liquid handling system in accordance with some embodiments.

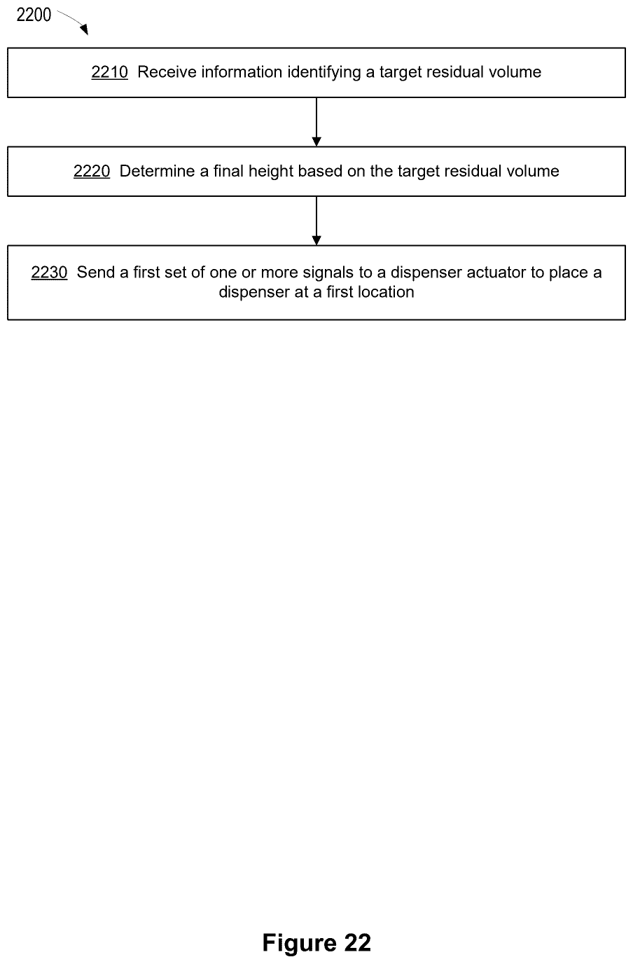

The liquid handling system includes one or more processors 480, which are in communication with a computer-readable storage medium 482 (e.g., transitory computer readable storage medium or non-transitory computer memory devices, such as random-access memory, read-only memory, static random-access memory, and other non-volatile memory, and other storage devices, such as a hard drive, an optical disk, a magnetic tape recording, or any combination thereof) storing instructions for performing any methods described herein (e.g., operations described with respect to FIGS. 22-28). The one or more processors 380 are also in communication with an input/output controller 484 (via a system bus or any suitable electrical circuit). In some embodiments, the input/output controller 484 receives sensor data from one or more sensors 470-1, 470-2, etc., and relays the sensor data to the one or more processors 480. The input/output controller 484 also receives instructions and/or data from the one or more processors 480 and relays the instructions and/or electrical signals to one or more actuators in various components, such as first transferrer actuator 488-1, second transferrer actuator 488-2, first liquid transferrer 488-3, and second liquid transferrer 488-4, etc. In some embodiments, the input/output controller 484 is coupled to one or more actuator controllers 486 and provides instructions and/or data to at least a subset of the one or more actuator controllers 486, which, in turn, provide control signals to selected actuators. In some embodiments, the one or more actuator controller 486 are integrated with the input/output controller 484 and the input/output controller 484 provides control signals directly to the one or more actuators 487 (without a separate actuator controller). Although FIG. 4 shows that there is one actuator controller 486 (e.g., one actuator controller for the entire liquid handling system), in some embodiments, the liquid handling system includes additional actuator controllers (e.g., one actuator controller for each actuator, etc.). In some embodiments, the one or more processors 480 are in communication with one or more user interface devices 472 (e.g., displays and one or more user input devices, such as a keyboard, a mouse, a touch screen, etc.) for presenting information and/or receiving user inputs.

### Liquid Exchange Operation

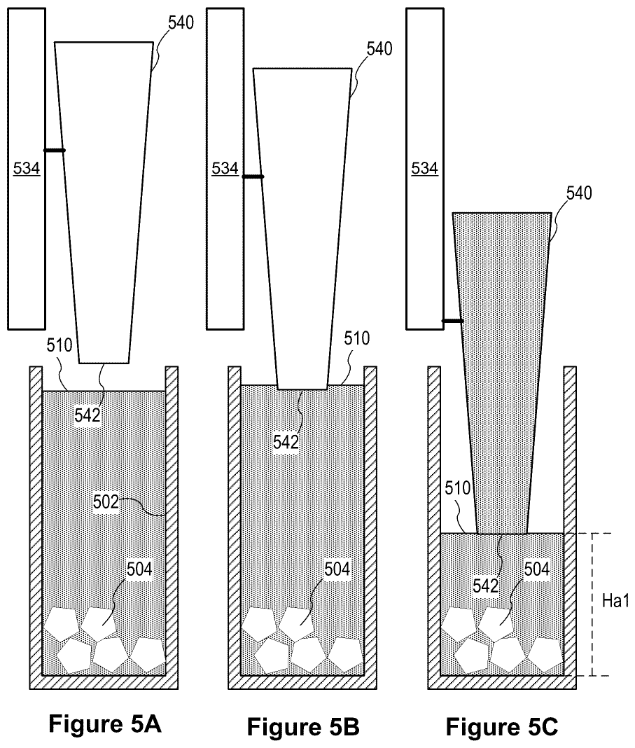

FIGS. 5A-5C are schematic diagrams illustrating an aspiration operation in accordance with some embodiments.

FIG. 5A illustrates a sample solution 510 in a liquid container 502 (e.g., a tube or a portion of a plate, such as the plate 100). The sample solution 510 contains a plurality of particles 504 (e.g., cells, beads, etc.). In some embodiments, as shown in FIG. 5A, the plurality of particles 504 is positioned (e.g., settled) toward a bottom of the sample solution 510.

FIG. 5A also illustrates a liquid exchange apparatus with a liquid transferrer 540 (e.g., an electronic pipette) and an actuator 534 coupled with the liquid transferrer 540. The actuator 534 is capable of moving and/or positioning the liquid transferrer 540. In some embodiments, as shown in FIG. 5A, a tip 542 of a nozzle of the liquid transferrer 540 is positioned away from the sample solution 510.

FIG. 5B illustrates that the actuator 534 has moved the liquid transferrer 540 downward so that the tip 542 of the nozzle of the liquid transferrer 540 is in contact with the sample solution 510.

FIG. 5C illustrates that the liquid transferrer 540 has aspirated a portion of the sample solution 510. FIG. 5C also illustrates that the tip 542 of the nozzle of the liquid transferrer 540 is at a height Ha1.

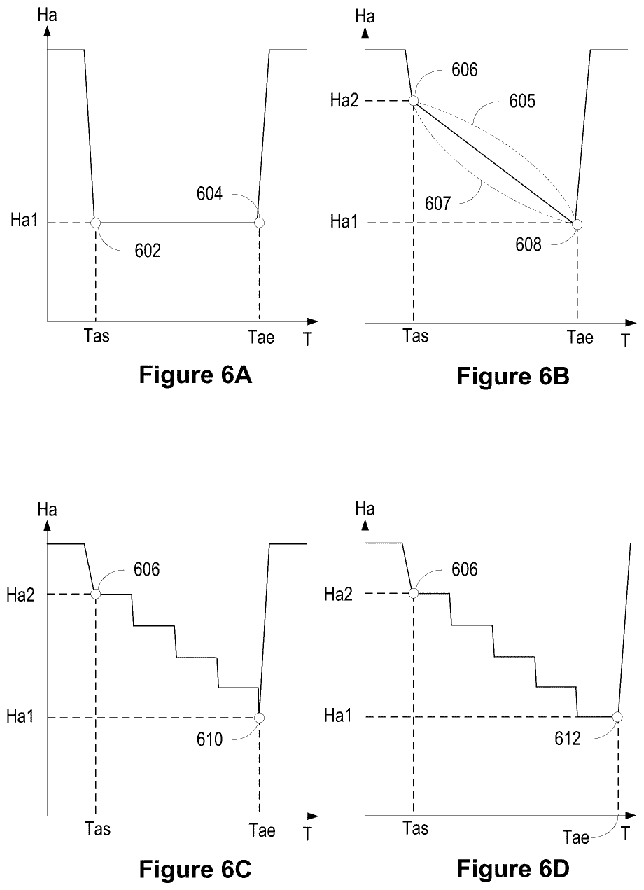

FIGS. 6A-6D illustrate example height profiles during an aspiration operation in accordance with some embodiments.

FIG. 6A shows a height profile representing that the tip 542 of the nozzle of the liquid transferrer 540 is located at a predefined height Ha1 at the beginning of the aspiration operation at time Tas (602). In some embodiments, as shown in FIG. 6A, the tip 542 of the nozzle of the liquid transferrer 540 is placed above the predefined height Ha1 prior to Tas and is brought down to the predefined Ha1 prior to the beginning of the aspiration operation.

FIG. 6A also shows that the tip 542 of the nozzle of the liquid transferrer 540 is maintained at the predefined height Ha1 from at least the beginning of the aspiration operation at time Tas through the completion of the aspiration operation at time Tae (604) (e.g., as shown in FIG. 5C). In some embodiments, as shown in FIG. 6A, the tip 542 of the nozzle of the liquid transferrer 540 is placed above the predefined height Ha1 subsequent to the completion of the aspiration operation at time Tae (e.g., the liquid transferrer 540 is moved upward).

In some examples, a tip may go upward and break off from the liquid and then reposition within the liquid, for example, Ha1, during the aspiration. This movement is to reduce the dead zones which may exist around a tip during the aspiration. In some embodiments, this modification applies to any aspiration operation including the height profiles of aspiration shown in FIG. 6A, 6B, 6C, and 6D.

FIG. 6B shows a height profile representing that the tip 542 of the nozzle of the liquid transferrer 540 is located at a predefined height Ha2 greater than the height Ha1 at the beginning of the aspiration operation at time Tas (606) (e.g., as shown in FIG. 5B). In some embodiments, as shown in FIG. 6B, the tip 542 of the nozzle of the liquid transferrer 540 is placed above the predefined height Ha2 prior to Tas (e.g., as shown in FIG. 5A) and is brought down to the predefined Ha2 prior to the beginning of the aspiration operation.

FIG. 6B also shows that the height of the tip 542 of the nozzle of the liquid transferrer 540 decreases over time from Ha2 from the beginning of the aspiration operation at time Tas to the predefined height Ha1 at the completion of the aspiration operation at time Tae (608). Although FIG. 6B illustrates that the height of the tip 542 of the nozzle of the liquid transferrer 540 decreases linearly over time from the beginning of the aspiration operation at time Tas through the completion of the aspiration operation at time Tae, in some embodiments, the height of the tip 542 of the nozzle of the liquid transferrer 540 decreases non-linearly over time from the beginning of the aspiration operation at time Tas through the completion of the aspiration operation at time Tae (e.g., along a path 605 or 607 shown in FIG. 6B). In some embodiments, as shown in FIG. 6B, the tip 542 of the nozzle of the liquid transferrer 540 is placed above the predefined height Ha1 subsequent to the completion of the aspiration operation at time Tae (e.g., the liquid transferrer 540 is moved upward).

FIG. 6C shows a height profile representing that the tip 542 of the nozzle of the liquid transferrer 540 is located at the predefined height Ha2 greater than the height Ha1 at the beginning of the aspiration operation at time Tas (606). In some embodiments, as shown in FIG. 6C, the tip 542 of the nozzle of the liquid transferrer 540 is placed above the predefined height Ha2 prior to Tas and is brought down to the predefined Ha2 prior to the beginning of the aspiration operation.

FIG. 6C also shows that the height of the tip 542 of the nozzle of the liquid transferrer 540 decreases over time stepwise from Ha2 from the beginning of the aspiration operation at time Tas to the predefined height Ha1 at the completion of the aspiration operation at time Tae (610). In some embodiments, as shown in FIG. 6C, the tip 542 of the nozzle of the liquid transferrer 540 is placed above the predefined height Ha1 subsequent to the completion of the aspiration operation at time Tae (e.g., the liquid transferrer 540 is moved upward).

FIG. 6D shows a height profile similar to the height profile shown in FIG. 6C except that the height profile shown in FIG. 6D includes maintaining the tip 542 of the nozzle of the liquid transferrer 540 at the predefined height Ha1 for a predefined duration (612) while the height profile shown in FIG. 6C does not include maintaining the tip 542 of the nozzle of the liquid transferrer 540 at the predefined height Ha1 (e.g., the height profile shown in FIG. 6C includes moving the tip 542 of the nozzle of the liquid transferrer 540 down to the predefined height Ha1 followed by immediately moving the tip 542 of the nozzle of the liquid transferrer 540 up).

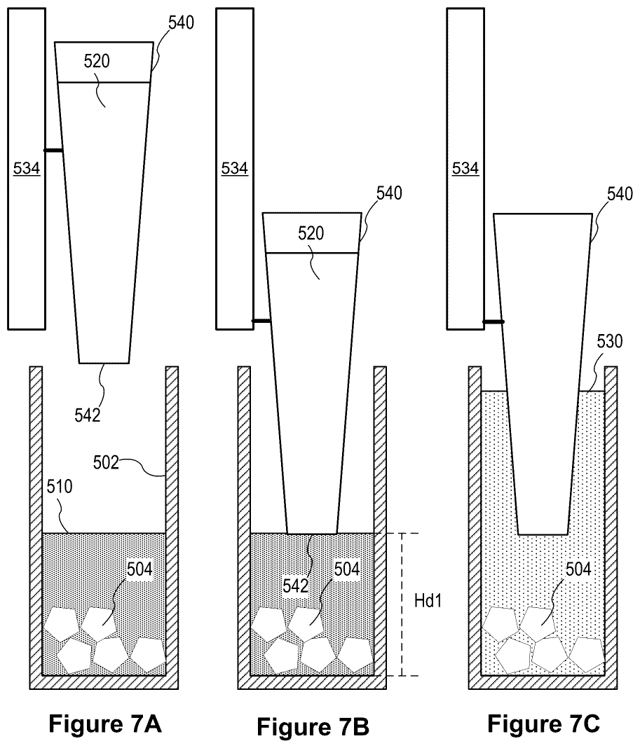

FIGS. 7A-7C are schematic diagrams illustrating a dispensing operation in accordance with some embodiments.

FIG. 7A illustrates the sample solution 510 in the liquid container 502. As described with respect to FIGS. 5A-5C, the sample solution 510 contains a plurality of particles 504 (e.g., cells, beads, etc.). In some embodiments, FIG. 7A illustrates a state after an aspiration operation illustrated in FIGS. 5A-5C.

FIG. 7A also illustrates that the liquid transferrer 540 contains a wash liquid 520.

FIG. 7B illustrates that the actuator 534 has moved the liquid transferrer 540 downward so that the tip 542 of the nozzle of the liquid transferrer 540 is in contact with the sample solution 510. FIG. 7B also illustrates that the tip 542 of the nozzle of the liquid transferrer 540 is at a height Hd1.

FIG. 7C illustrates that the liquid transferrer 540 has dispensed the wash liquid 520, thereby causing a mixture of the sample solution 510 and the wash liquid 520. As illustrated in FIG. 7C, the plurality of particles 504 substantially remain in the mixed solution, whereas the concentration of other components (e.g., debris, undesired solutes, etc.) is reduced. By repeating the aspiration and dispensing operations illustrated in FIGS. 5A-5C and 7A-7C, the concentration of particles 504 is substantially maintained in a resulting solution while the concentration of other components is substantially diluted compared to the concentration of particles 504, thereby achieving the washing effect.

For an efficient washing, a solution (e.g., the wash liquid 520) is added to a liquid container containing cells or particles, where the incoming solution (e.g., the wash liquid) needs to be mixed with the existing solution in the container while minimizing the resuspension of the cells or particles. For this purpose, in some embodiments, a liquid transferrer (or its nozzle or a pipette tip coupled with the liquid transferrer) remains immersed in the solution while the aspirating (e.g., FIGS. 5B and 5C) and/or dispensing (e.g., FIGS. 7B and 7C) are repeated several times. This leads to the mixing of the solution while minimizing the resuspension of cells or particles. In some embodiments, the liquid transferrer (or its nozzle or a pipette tip coupled with the liquid transferrer) remains in a contact with the solution at all the time of the process (e.g., both the aspiration and dispensing operations). In some embodiments, the liquid transferrer (or its nozzle or a pipette tip coupled with the transferrer) remains in a contact with the solution while aspirating 10-90% of the total volume (e.g., the total volume of an original sample solution or a mixture of a remaining portion of the original sample solution and the dispensed wash liquid). In some embodiments, the nozzle or the pipette tip coupled with the liquid transferrer is positioned at 1 mm-10 mm from the bottom of the liquid container. In some embodiments, the wash liquid is dispensed at a flow rate between 5 and 20 μl/s. In some embodiments, the mixture (e.g., a mixture of the original sample solution or a portion thereof with the wash liquid) is aspired at a flow rate between 5 and 20 μl/s.

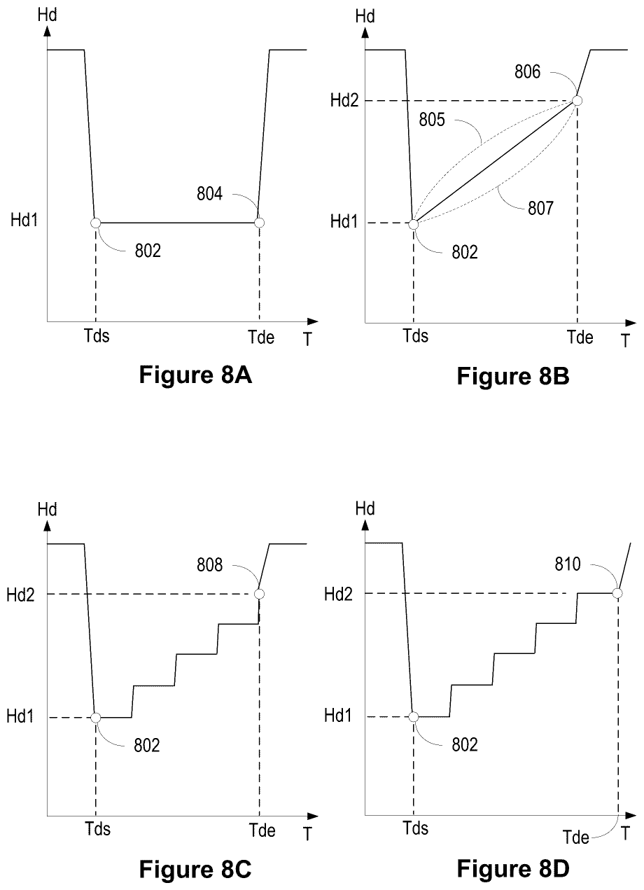

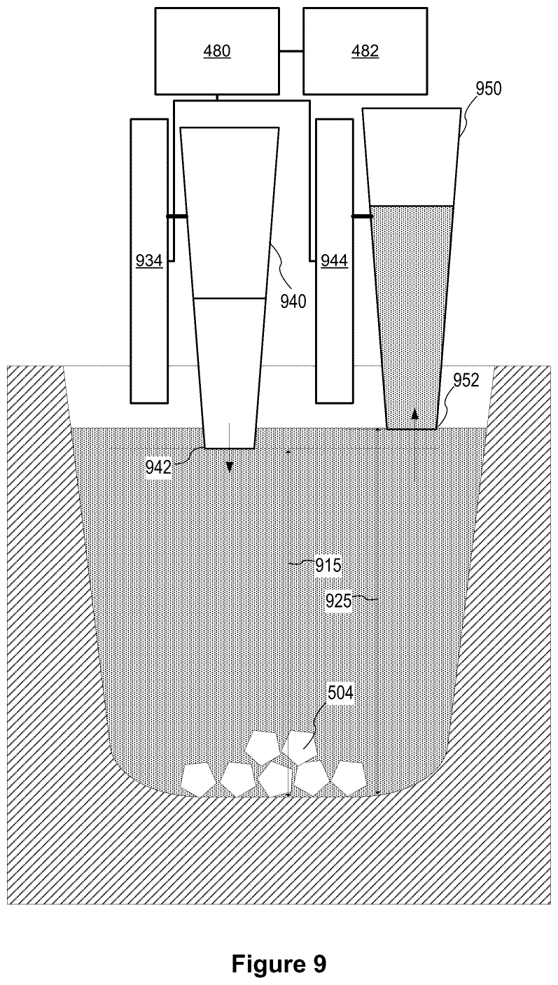

FIGS. 8A-8D illustrate example height profiles during a dispensing operation in accordance with some embodiments.

FIG. 8A shows a height profile representing that the tip 542 of the nozzle of the liquid transferrer 540 is located at a predefined height Hd1 at the beginning of the dispensing operation at time Tds (802). In some embodiments, as shown in FIG. 8A, the tip 542 of the nozzle of the liquid transferrer 540 is placed above the predefined height Ha1 prior to Tds and is brought down to the predefined Hd1 prior to the beginning of the dispensing operation.

FIG. 8A also shows that the tip 542 of the nozzle of the liquid transferrer 540 is maintained at the predefined height Hd1 (e.g., as shown in FIG. 7B) from at least the beginning of the dispensing operation at time Tds through the completion of the dispensing operation at time Tde (804). In some embodiments, as shown in FIG. 8A, the tip 542 of the nozzle of the liquid transferrer 540 is placed above the predefined height Hd1 subsequent to the completion of the dispensing operation at time Tde (e.g., the liquid transferrer 540 is moved upward).

FIG. 8B shows a height profile representing that the tip 542 of the nozzle of the liquid transferrer 540 is located at a predefined height Hd1 at the beginning of the dispensing operation at time Tds (802). In some embodiments, as shown in FIG. 8B, the tip 542 of the nozzle of the liquid transferrer 540 is placed above the predefined height Hd1 prior to Tds and is brought down to the predefined Hd1 prior to the beginning of the dispensing operation.

FIG. 8B also shows that the height of the tip 542 of the nozzle of the liquid transferrer 540 increases over time from Hd1 from the beginning of the dispensing operation at time Tds to a predefined height Hd2 greater than the height Hd1 at the completion of the dispensing operation at time Tde (806). Although FIG. 8B illustrates that the height of the tip 542 of the nozzle of the liquid transferrer 540 increases linearly over time from the beginning of the dispensing operation at time Tds through the completion of the dispensing operation at time Tde, in some embodiments, the height of the tip 542 of the nozzle of the liquid transferrer 540 decreases non-linearly over time from the beginning of the dispensing operation at time Tds through the completion of the dispensing operation at time Tde (e.g., along a path 805 or 807 shown in FIG. 8B). In some embodiments, as shown in FIG. 8B, the tip 542 of the nozzle of the liquid transferrer 540 is placed above the predefined height Hd2 subsequent to the completion of the dispensing operation at time Tde (e.g., the liquid transferrer 540 is moved upward). In some embodiments, the tip 542 of the nozzle of the liquid transferrer 540 is placed just below the liquid level and maintains a similar position as the liquid level rises along with dispensing. The distance from the liquid level to the tip may be in the range of 0-100 mm, for example, and more specifically 0-2 mm. This example may apply to the embodiments illustrated in FIG. 8C and FIG. 8D.

FIG. 8C shows a height profile representing that the tip 542 of the nozzle of the liquid transferrer 540 is located at the predefined height Hd1 at the beginning of the dispensing operation at time Tds (802). In some embodiments, as shown in FIG. 8C, the tip 542 of the nozzle of the liquid transferrer 540 is placed above the predefined height Hd1 (and the predefined height Hd2) prior to Tds and is brought down to the predefined Hd1 prior to the beginning of the dispensing operation.

FIG. 8C also shows that the height of the tip 542 of the nozzle of the liquid transferrer 540 increases over time stepwise from Hd1 from the beginning of the dispensing operation at time Tds to the predefined height Hd2 at the completion of the dispensing operation at time Tde (808). In some embodiments, as shown in FIG. 8C, the tip 542 of the nozzle of the liquid transferrer 540 is placed above the predefined height Hd2 subsequent to the completion of the dispensing operation at time Tde (e.g., the liquid transferrer 540 is moved upward).

FIG. 8D shows a height profile similar to the height profile shown in FIG. 8C except that the height profile shown in FIG. 8D includes maintaining the tip 542 of the nozzle of the liquid transferrer 540 at the predefined height Hd2 for a predefined duration (810) while the height profile shown in FIG. 8C does not include maintaining the tip 542 of the nozzle of the liquid transferrer 540 at the predefined height Hd2 (e.g., the height profile shown in FIG. 8C includes moving the tip 542 of the nozzle of the liquid transferrer 540 up to the predefined height Hd2 followed by continuing to move the tip 542 of the nozzle of the liquid transferrer 540 up).

FIG. 9 is a schematic diagram illustrating a washer apparatus in accordance with some embodiments.

Although FIGS. 5A-5C and 7A-7C illustrate a washing operation (a combination of the aspiration operation and the dispensing operation) performed using a single liquid transferrer (e.g., a pipette), the washing operation may be performed by using an aspirator and a dispenser that is distinct and separate from the aspirator.

For example, the washer apparatus shown in FIG. 9 includes an aspirator 950 and a dispenser 940 that is distinct and separate from the aspirator 950. The aspirator 950 is coupled with an aspirator actuator 944. The aspirator actuator 944 moves the aspirator 950 (e.g., vertically). The dispenser 940 is coupled with a dispenser actuator 934. The dispenser actuator 934 moves the dispenser 940 (e.g., vertically). In some embodiments, the dispenser actuator 934 moves the dispenser 940 independently from the aspirator 950, and the aspirator actuator 944 moves the aspirator 950 independently from the dispenser 940. For example, a height 915 of a tip 942 of a nozzle of the dispenser 940 may be set independently from a height 925 of a tip 952 of a nozzle of the aspirator 950.

In some embodiments, the aspirator actuator 944 and the dispenser actuator 934 are in communication with one or more processors 480. The one or more processors 480 provide electrical signals (e.g., instructions) to the aspirator actuator 944 and/or the dispenser actuator 934. In some embodiments, the washer apparatus includes one or more processors 480 and memory 482 storing instructions for moving the aspirator 950 and the dispenser 940.

### Experimental Results

In some applications, it is important to retain a large portion of the cells or particles during for a washing operation. To determine the effects of a height of aspiration (e.g., a height of a tip of a nozzle of a liquid transferrer during an aspiration operation) and a height of dispensing (e.g., a height of a tip of a nozzle of a liquid transferrer during a dispensing operation), various combinations of aspiration heights and dispensing heights were tested.

In performing this test, sample solutions containing 7-micron diameter beads at 0.25 M concentration, live peripheral blood mononuclear cells (PBMC), or permeabilized fixed PMBC were left for a total of 33 minutes to allow the beads or cells to settle. Each solution with settled beads or cells was washed four times, and the amount of remaining beads or cells was measured in each solution.

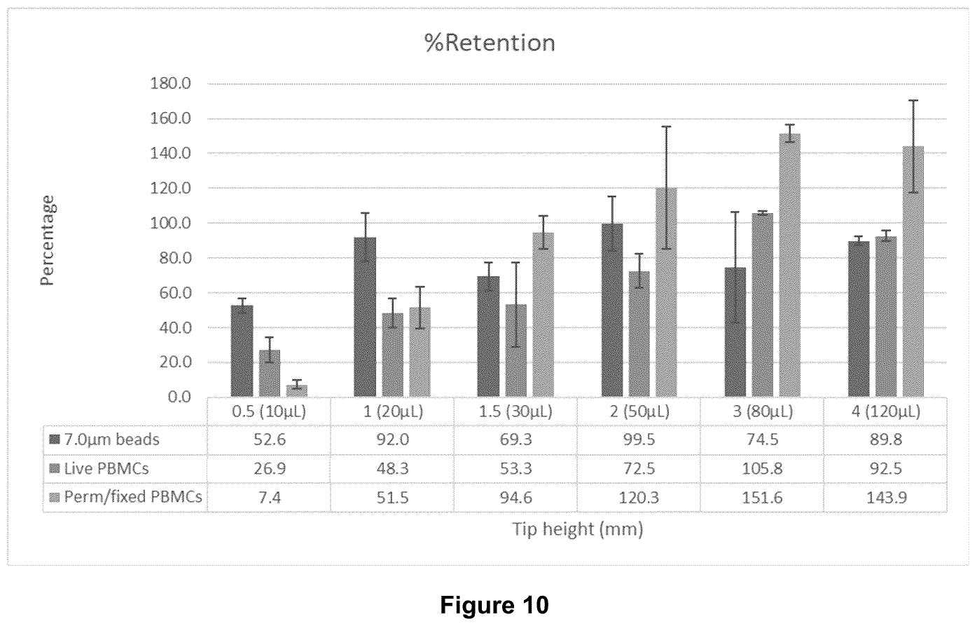

As shown in FIG. 10, the results show that the bead/cell retention was significantly lower when the lowest height for aspiration and dispensing was 1.0 mm or less. Generally, the bead/cell retention was superior for a height of 1.5 mm or greater. However, given that the washing efficiency decreases significantly from the height of 4.0 mm (due to the increased volume of the residual liquid), a height between 1.5 mm and 3.0 mm (inclusive) has been determined to be an optimal range. In particular, a height of approximately 2.00 mm was found to be particularly effective for both cell retention and washing efficiency.

In addition, given that the conventional washing methods requiring centrifugation typically lose 5˜25% of cells in each wash cycle (retaining approximately 31˜81% of cells after four cycles of washing), the experimental data shows that the washing methods that do not require centrifugation as described herein provide cell retention comparable or superior to conventional methods using centrifugation.

Integrating a centrifuge with an automated, robotic system is challenging, because centrifuges, which rotate samples at a ultra-high speed to provide an increase acceleration, typically require a secure loading and locking mechanism, which is difficult to operate with a robotic system.

The devices and methods for washing a sample as described herein do not require a centrifuge, and a result, allow integration of a washing operation into robotic liquid handling systems, thereby enabling such robotic liquid handling systems (e.g., the liquid handling system 300) to perform assays and sample preparations automatically (e.g., fully automated sample preparation without user intervention or semi-automated sample preparation requiring fewer user intervention).

### Data Structure

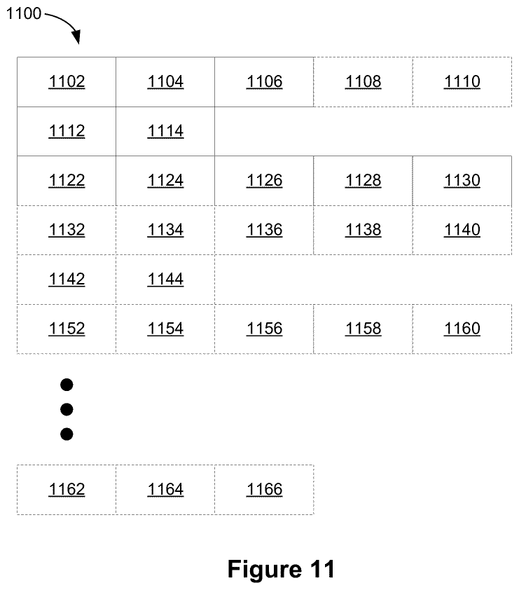

FIG. 11 is a schematic diagram illustrating a data structure 1100 for operation of a liquid handling system in accordance with some embodiments. In some embodiments, the data structure 1100 is stored in the memory 482 for a washing operation.

In some embodiments, the data structure 1100 includes information for transferring a solution. For example, in some embodiments, the data structure 1100 includes at least one of:
information 1102 identifying a source location from which to transfer a solution (e.g., a deck and/or a well where a reagent or sample solution is located);
information 1104 identifying a destination to which to transfer the solution (e.g., a deck and/or a well where the solution is to be transferred to); or
information 1106 identifying a volume to transfer.

In some embodiments, the data structure 1100 also includes at least one of:
information 1108 identifying a tilting duration (during which a sample will be maintained in a tilted container), where a tilting duration of zero may indicate that no tilting is to be performed; or
information 1110 identifying a tilting angle (at which the sample will be tilted).

In some embodiments, the data structure 1110 includes information for incubating a sample. For example, in some embodiments, the data structure 1100 includes at least one of:
information 1112 identifying an incubation time; or
information 1114 identifying an incubation temperature.

In some embodiments, the data structure 1110 includes information for washing a sample. For example, in some embodiments, the data structure 1100 includes at least one of:
information 1122 identifying a source location for a wash buffer (e.g., a deck, a reservoir, and/or a well where a wash liquid is located);
information 1124 identifying an initial volume of liquid for a washing operation (e.g., the initial volume of liquid expected in the sample container);
information 1126 identifying a final volume of liquid for the washing operation (e.g., the volume of liquid after an aspiration operation);
information 1128 identifying a flow rate (e.g., 5 μL/s) for the aspiration operation and/or the dispensing operation; or
information 1130 identifying a number of washing cycles to be performed.

In some embodiments, processing a sample solution (e.g., an assay) requires multiple cycles of transferring solutions, incubation, and washing operations. In some embodiments, the data structure 1100 includes additional data (e.g., information 1132, 1134, 1136, 1138, and 1140, which correspond to information 1102, 1104, 1106, 1108, and 1110, for a second transfer operation; information 1142 and 1144, which correspond to information 1112 and 1114, for a second incubation operation; and information 1152, 1154, 1156, 1158, and 1160, which correspond to information 1122, 1124, 1126, 1128, and 1130, for a second washing operation) especially when a subsequent cycle of solution transfer, incubation, or washing operation is carried out using different parameters.

In some embodiments, the data structure 1110 includes information for preparing a final solution. For example, in some embodiments, the data structure 1110 includes at least one of:
information 1162 identifying a source location for a buffer to be used in the final solution (e.g., a deck, a reservoir, and/or a well where an assay buffer is located);
information 1164 identifying a final location where the final solution is to be located (e.g., a deck and/or a well where tubes for the final solution, such as FACS tubes, are located); and
information 1166 identifying a final volume of the final solution to be transferred to the final location.

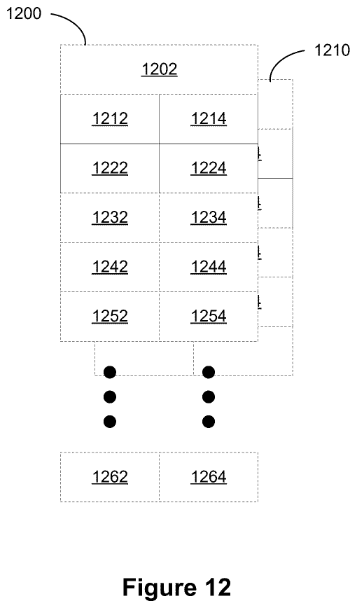

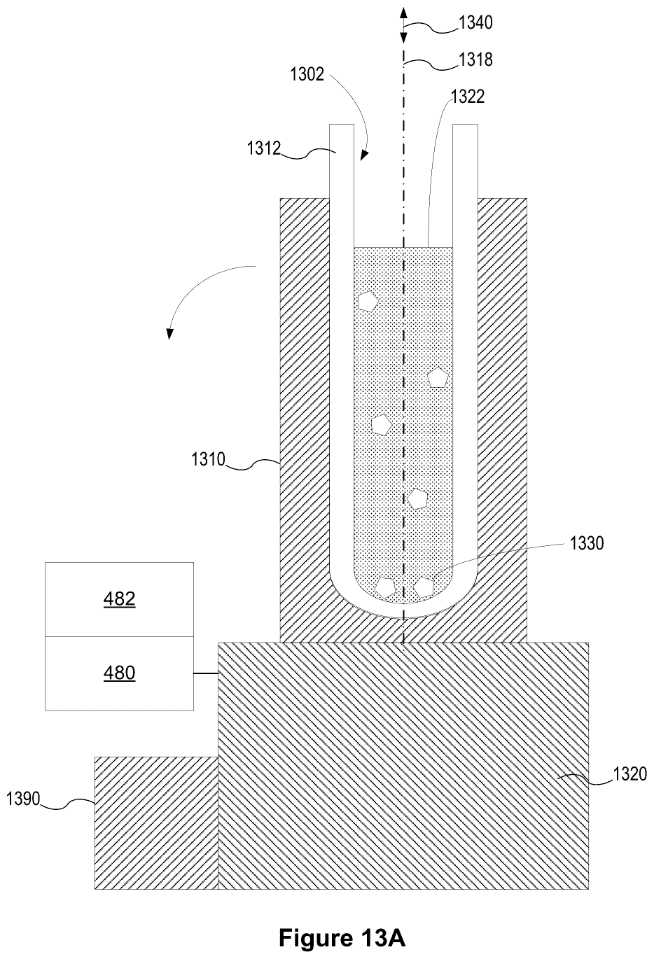

FIG. 12 is a schematic diagram illustrating a lookup table 1200 for washing operations in accordance with some embodiments.

As described herein, the height (e.g., the lowest height) for an aspiration operation and/or a dispensing operation affects cell retention. However, most assay recipes are designed for a certain volume of a sample solution. In some embodiments, a liquid handling system utilizes a lookup table to determine a recommended height for the aspiration operation and/or the dispensing operation for a particular liquid volume. In some embodiments, the lookup table is stored in the memory 482 for a washing operation.

In some embodiments, the lookup table 1200 includes information 1202 identifying a liquid container (e.g., a size and/or shape of the liquid container). The lookup table 1200 also includes information identifying a plurality of volume values (e.g., information 1212, 1222, 1232, 1242, 1252, and 1262) and information identifying corresponding heights (e.g., information 1214, 1224, 1234, 1244, 1254, and 1264, where information 1214 identifies a height for aspiration and/or dispensing for a liquid having a (initial) volume corresponding to the value identified by information 1212).

FIGS. 13A-13M illustrate an apparatus with a tilting device for separating biological cells in accordance with some embodiments.

In FIG. 13A, the apparatus includes a receptacle holder 1310 and a tilting device 1320. In some embodiments, the apparatus also includes an impulse device 1390. In some embodiments, the impulse device 1390 provides discrete mechanical impulses (e.g., tapping). In some embodiments, the impulse device 1390 provides vibration or shaking.

As shown in FIG. 13A, in operation, a receptacle 1312 (e.g., a tube) containing a solution 1322 with biological cells 1330 or particles may be placed in the receptacle holder 1310.

In some embodiments, the receptacle holder 1310 is in a second orientation. In some embodiments, the second orientation is a substantially vertical orientation as shown in FIG. 13A. In some embodiments, the receptacle holder 1310 is deemed to be in a substantially vertical orientation when a channel defined by a receptacle to be held by the receptacle holder 1310 defines an axis that is in a substantially vertical orientation. In some embodiments, the receptacle holder 1310 (e.g., a tube holder) is deemed to be in a substantially vertical orientation when a channel defined by the receptacle holder 1310 (e.g., a channel into which the tube is to be inserted) defines an axis that is in a substantially vertical orientation. For example, a first axis 1318 defined by the channel 1302 of the receptacle 1312 or a channel of the receptacle holder 1310 is substantially vertical (e.g., the axis 1318 is substantially parallel to a vertical direction 1340). In some embodiments, the receptacle holder 1310 (e.g., a plate holder) is deemed to be in a substantially vertical orientation when a base surface of the receptacle holder 1310 is substantially perpendicular to the vertical direction 1340.

FIG. 13A also shows one or more processors 480 and memory 482 storing one or more programs for execution by the one or more processors 480. In some embodiments, the one or more programs include instructions that cause the one or more processors 480 to send one or more signals or instructions to devices in communications with the one or more processors 480 (e.g., the tilting device 1320, an aspirator, a dispenser, etc.).

In addition, FIG. 13A shows that the receptacle holder 1310 is to be rotated or tilted by the tilting device 1320.

FIG. 13B illustrates that the receptacle holder 1310 is in a first orientation. In some embodiments, the first orientation is a non-vertical orientation as shown in FIG. 13B. In some embodiments, the receptacle holder 1310 is deemed to be in a non-vertical orientation when the channel defined by the receptacle to be held by the receptacle holder 1310 defines an axis that is in a non-vertical orientation. In some embodiments, the receptacle holder 1310 (e.g., a tube holder) is deemed to be in a non-vertical orientation when a channel defined by the receptacle holder 1310 (e.g., a channel into which the tube is to be inserted) defines an axis that is in a non-vertical orientation (e.g., the axis has a non-zero angle 1342 with respect to the vertical direction). For example, the first axis 1318 defined by the channel 302 of the receptacle 1312 or a channel of the receptacle holder 1310 is non-vertical (e.g., the axis 1318 is non-parallel to the vertical direction 1340). In some embodiments, the receptacle holder 1310 (e.g., a plate holder) is deemed to be in a non-vertical orientation when a base surface of the receptacle holder 1310 is non-perpendicular to the vertical direction 1340.

FIG. 13C shows that the receptacle holder 1310 is maintained in the first orientation. The tilting of the channel defined by the receptacle 1312 speeds up settling of the biological cells or particles.

FIG. 13C also shows that the receptacle holder 1310 is to be rotated or tilted back by the tilting device 1320 (after a predefined time).

FIG. 13D illustrates that the receptacle holder 1310 is in the second orientation. In FIG. 13D, the biological cells 1330 or particles are settled down to a bottom of the receptacle. In some cases, because the biological cells 1330 or particles settled while the receptacle was in a tilted orientation, the biological cells 1330 or particles may have settled in a non-symmetric manner (e.g., the biological cells 1330 or particles may pile more on one end than an opposing end when the receptacle is positioned in a vertical orientation). For example, a top surface defined by the settled biological cells 1330 or particles may be non-perpendicular to the vertical direction while the receptacle holder 1310 or the receptacle 1312 is in the vertical orientation as shown in FIG. 13D.

FIG. 13E illustrates that, in some embodiments, one or more mechanical impulses (and/or vibration or shaking) are provided to the receptacle 1312 or the receptacle holder 1310. In some cases, the one or more mechanical impulses cause the biological cells 1330 or particles to redistribute. In some cases, the redistribution of the biological cells 1330 or particles causes a top surface defined by the settled biological cells 1330 or particles to be substantially perpendicular to the vertical direction while the receptacle holder 1310 or the receptacle 1312 is in the vertical orientation as shown in FIG. 13E.

FIG. 13F illustrates an aspirator 1350 (e.g., a liquid transferrer) or its tip. In some embodiments, the aspirator 1350 aspirates at least a portion of the solution 1322 (and any substances not settled down with the biological cells 1330 or particles, such as non-cellular substances).

FIG. 13G illustrates that a portion 1322-1 (e.g., a large portion corresponding to more than 50%) of the solution 1322 is aspirated. A remaining portion 1322-2 of the solution 1322 with the biological cells 1330 is left in the receptacle 1312. The aspirated portion 1322-1 is also illustrated in the inset of FIG. 13G to show that the aspirated portion 1322-1 has no or a low concentration of biological cells whereas the remaining portion 1322-2 has a high concentration of biological cells.

FIG. 13H illustrates a dispenser 1360 (e.g., a liquid transferrer) or its tip. In some embodiments, the dispenser 1360 is distinct from the aspirator 1350. In some embodiments, the dispenser 1360 dispenses a different solution (e.g., a wash buffer), which is mixed with the remaining portion 1322-2 of the solution 1322 to form a mixed solution 1370. By providing the different solution (e.g., the wash buffer), the concentration of any substances not settled down with the biological cells 1330 or particles, such as non-cellular substances, decreases.

In some embodiments, the aspiration of a portion of a solution in the receptacle and dispensing of additional solution are repeated to further decrease the concentration of any substances not settled down with the biological cells 1330 or particles, such as non-cellular substances.

In some embodiments, the dispenser 1360 or another dispenser provides one or more reagents.

FIG. 13I illustrates the aspirator 1350 (e.g., a liquid transferrer) or its tip. In some embodiments, the aspirator 1350 aspirates at least a portion of the solution 1370 (and any substances not settled down with the biological cells 1330 or particles, such as non-cellular substances).

FIG. 13J illustrates that a portion 1370-1 (e.g., a large portion corresponding to more than 50%) of the solution 1370 is aspirated. A remaining portion 1370-2 of the solution 1370 with the biological cells 1330 is left in the receptacle 1312. The aspirated portion 1370-1 is also illustrated in the inset of FIG. 13J to show that the aspirated portion 1370-1 has no or a low concentration of biological cells whereas the remaining portion 1370-2 has a high concentration of biological cells.

FIG. 13K illustrates the dispenser 1360 or its tip. In some embodiments, the dispenser 1360 dispenses a solution (e.g., an incubation buffer), which is mixed with the remaining portion of the solution 1370 to form a mixed solution 1380.

FIG. 13L illustrates the aspirator 1350 (e.g., a liquid transferrer) or its tip. In some embodiments, the aspirator 1350 aspirates at least a portion of the solution 1380.

FIG. 13M illustrates that a portion (e.g., a large portion or the entirety) of the solution 1380 is aspirated. The aspirated portion 1380-1 is also illustrated in the inset of FIG. 13M to show that the aspirated portion 1380-1 has a high concentration of biological cells 1330 whereas the remaining portion 1380-2 has no or a low concentration of biological cells.

Although the operations in FIGS. 13A-13M are illustrated with a tube, corresponding operations may be performed using a plate (e.g., the plate 100 shown in FIGS. 1 and 2). For brevity, such details are not repeated herein. The use of a plate having multiple channels allows concurrent separation operations for multiple samples or solutions.

As described with respect to FIG. 3, in some embodiments, the tilting device 1320 is included in a liquid handling system (e.g., the liquid handling system 300).

### Pipette Tip Clip

In performing a washing operation based on exchange of liquids as described herein, placement of a pipette tip may have a large impact on reliability of the washing operation. For example, in configurations with multiple nozzles, it may be required to align multiple pipette tips to reduce variability in a washing efficiency and a dilution factor between samples.

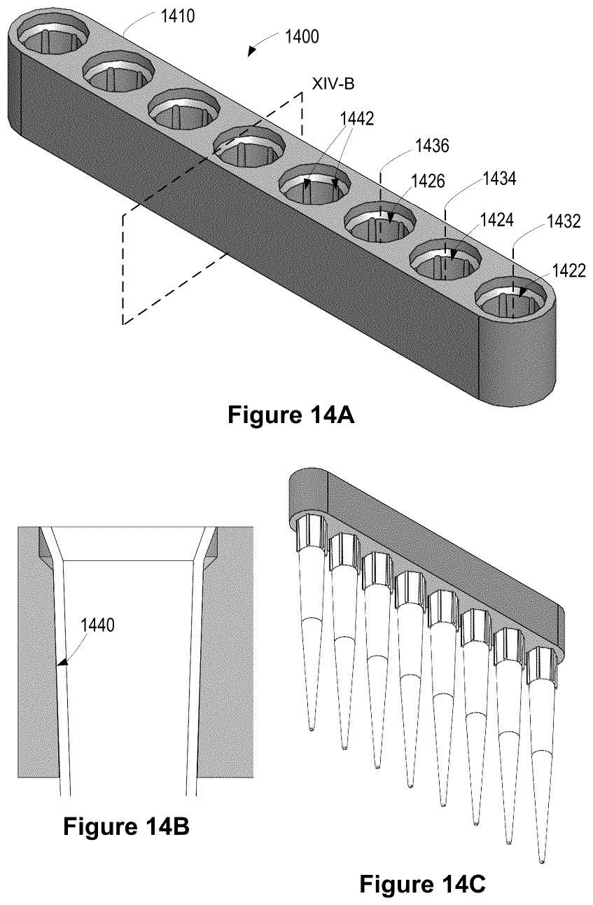

FIG. 14A illustrates a device 1400 for aligning pipette tips in accordance with some embodiments. The device 1400 includes a block 1410 that defines a plurality of through-holes (e.g., through-holes 1422, 1424, and 1426).

FIG. 14A also shows that, in some embodiments, one or more ribs 1432 are defined on a side wall of a respective through-hole of the plurality of through-holes.

Also shown in FIG. 14A are respective axes 1432, 1434, and 1436 defined by the plurality of through-holes 1422, 1424, and 1426. In some embodiments, as shown in FIG. 14A, the respective axes 1432, 1434, and 1436 are substantially parallel to one another (e.g., two axes form an angle of 10 degrees or less, 9 degrees or less, 8 degrees or less, 7 degrees or less, 6 degrees or less, 5 degrees or less, 4 degrees or less, 3 degrees or less, 2 degrees or less, or 1 degree or less).

In addition, in some embodiments, the plurality of through-holes 1422, 1424, and 1426 have substantially the same spacing between two adjacent through-holes. For example, the spacing between the through-holes 1422 and 1424 is substantially the same (e.g., differs by less than 20%, less than 15%, less than 10%, less than 5%, less than 4%, less than 3%, less than 2%, or less than 1%) as the spacing between the through-holes 1424 and 1426.

FIG. 14A further shows a plane XIV-B from which a cross-sectional view shown in FIG. 14B is taken.

FIG. 14B illustrates that a respective through-hole of the plurality of through-holes is configured (e.g., sized) to fit a pipette tip (e.g., fit with an outside of a pipette tip). For example, an inner diameter of the respective through-hole is substantially the same (adjusted by a tolerance) as an outer diameter of a pipette tip.

FIG. 14B also shows that, in some embodiments, at least a portion 1440 of a side wall of the respective through-hole of the plurality of through-holes has a predefined slope (e.g., the sloped portion is non-parallel to the axis defined by the through-hole). The sloped portion 1440 of the side wall facilitates coupling with a pipette tip.

FIG. 14C illustrates the device 1400 coupled with a plurality of pipette tips. In some embodiments, the device 1400 is mechanically coupled with a liquid transferrer (or a plurality of liquid transferrers) for aligning a plurality of pipette tips mounted (loaded) on the liquid transferrer (or the plurality of liquid transferrers).

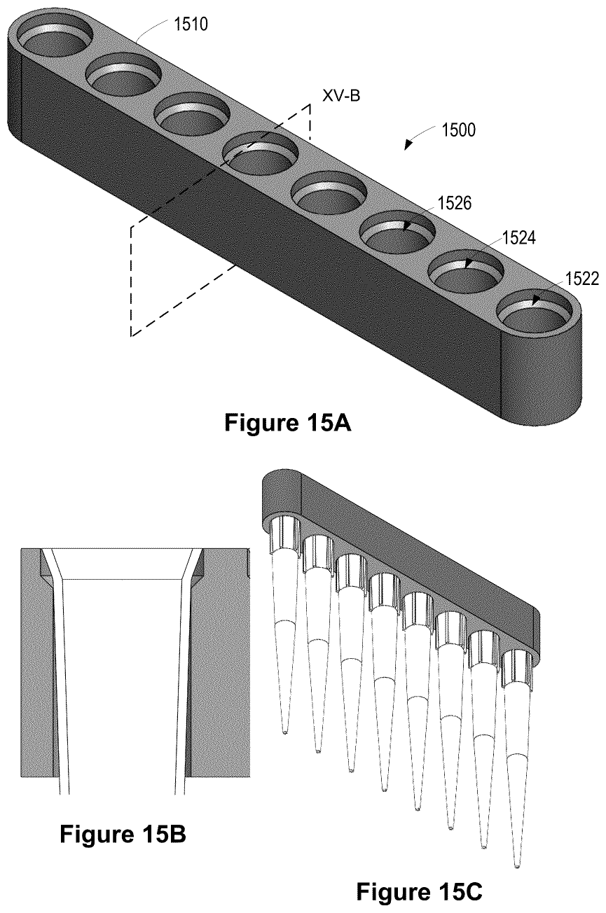

FIG. 15A illustrates a device 1500 for aligning pipette tips in accordance with some embodiments. The device 1500 includes a block 1510 that defines a plurality of through-holes (e.g., through-holes 1522, 1524, and 1526).

In some embodiments, the device 1500 is similar to the device 1400 described with respect to FIGS. 14A-14C, except that a respective through-hole of the device 1500 (e.g., through-hole 1522, 1524, or 1526) has a side wall that is free from one or more ribs (e.g., a side wall of the respective through-hole of the plurality of through-holes is free from one or more ribs).

FIG. 15A also shows a plane XV-B from which a cross-sectional view shown in FIG. 15B is taken.

The cross-sectional view shown in FIG. 15B is similar to the cross-sectional view shown in FIG. 14B.

FIG. 15C illustrates the device 1500 coupled with a plurality of pipette tips.

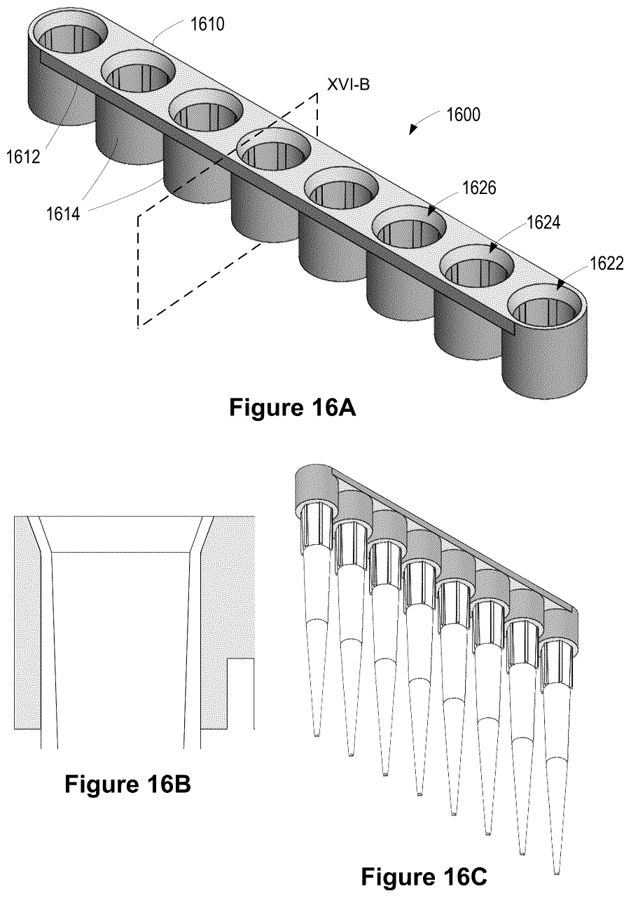

FIG. 16A illustrates a device 1600 for aligning pipette tips in accordance with some embodiments. The device 1600 includes a block 1610 that defines a plurality of through-holes (e.g., through-holes 1622, 1624, and 1626).

In some embodiments, the device 1600 is similar to the device 1400 described with respect to FIGS. 14A-14C, except that the block 1610 includes a plate portion 1612 and a plurality of barrel portions 1614 that are distinct from one another.

FIG. 16A also shows a plane XVI-B from which a cross-sectional view shown in FIG. 16B is taken.

The cross-sectional view shown in FIG. 16B is similar to the cross-sectional view shown in FIG. 14B.

FIG. 16C illustrates the device 1600 coupled with a plurality of pipette tips.

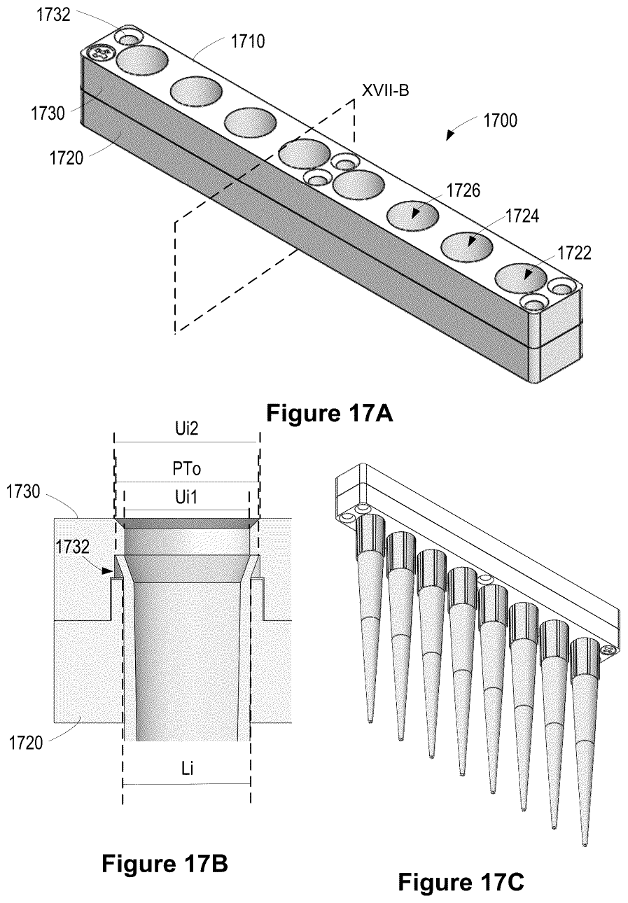

FIG. 17A illustrates a device 1700 for aligning pipette tips in accordance with some embodiments. The device 1700 includes a block 1710 that defines a plurality of through-holes (e.g., through-holes 1722, 1724, and 1726).

In some embodiments, the device 1700 is similar to the device 1400 described with respect to FIGS. 14A-14C, except that the block 1710 is divided into at least a lower block 1720 and an upper block 1730. In some embodiments, the lower block 1720 and the upper block 1730 have one or more aligned holes 1732 for securing the lower block 1720 and the upper block 1730 together (e.g., threaded or non-threaded holes).

FIG. 17A also shows a plane XVII-B from which a cross-sectional view shown in FIG. 17B is taken.

FIG. 17B shows that the lower block 1720 defines a through-hole characterized by an inner diameter Li less than a largest outer diameter PTo of a pipette tip and the upper block 1730 defines a through-hole characterized by an inner diameter Ui1 less than the largest outer diameter PTo of the pipette tip.

FIG. 17B also shows that the through-hole defined by the lower block 1720 and the through-hole defined by the upper block 1730 are aligned with each other.

Either the through-hole defined by the upper block 1730 or the corresponding through-hole defined by the lower block 1720 has a portion with an inner diameter greater than the largest outer diameter of the pipette tip. In FIG. 17B, the upper block 1730 has a portion 1732 with an inner diameter Ui2 greater than the largest outer diameter PTo of the pipette tip. This structure allows the upper block 1730 and the lower block 1720 to sandwich at least a portion of the pipette tip for securely positioning the pipette tip.

FIG. 17C illustrates the device 1700 coupled with a plurality of pipette tips.

### Pipette Tips

In performing a washing operation based on exchange of liquids as described herein, a shape or configuration of a pipette tip also impacts the performance of the washing operation.

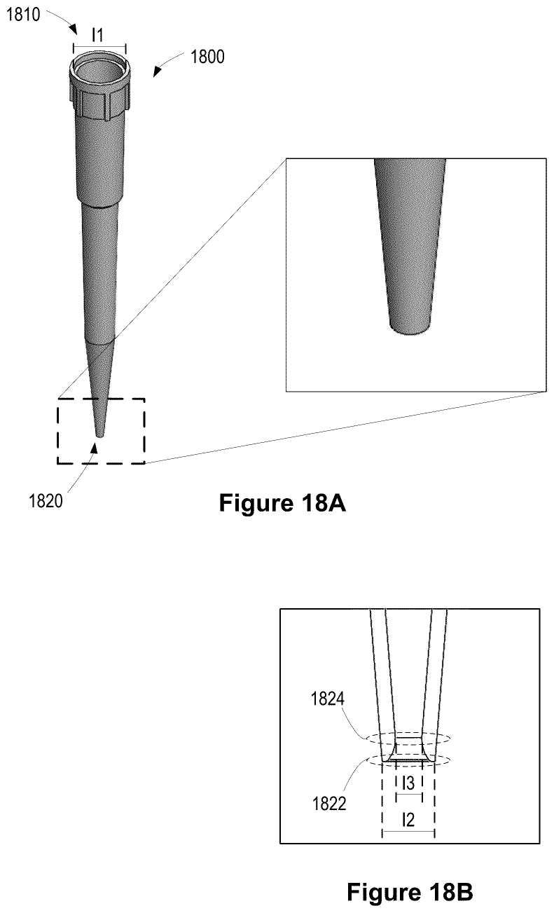

FIG. 18A illustrates a pipette tip 1800 in accordance with some embodiments. The pipette tip 1800 includes a tube (or a tubular structure) having a first end portion 1810 and a second end portion 1820 opposite to the first end portion 1810. As shown in FIG. 18A, the first end portion 1810 is characterized by a first inner diameter I1 and the second end portion 1820 is characterized by a second inner diameter (indicated as I2 in FIG. 18B) less than the first inner diameter I1 (e.g., the first end portion 1810 has a larger inner diameter than the second end portion 1820).

FIG. 18A also illustrates an enlarged view of the second end portion 1820 of the pipette tip 1800.

FIG. 18B shows a cross-sectional view of the second end portion 1820 of the pipette tip 1800 taken along a plane encompassing an axis of the pipette tip 1800 (e.g., a view taken from a center cut of the pipette tip 1800). The second end portion 1820 includes a first region 1822 located at a tip of the second end portion 1820 and a second region 1824 located away from the tip of the second end portion 1820. The first region 1822 is characterized by the second inner diameter I2 and the second region 1824 is characterized by a third inner diameter I3 less than the second inner diameter I2. This widening inner diameter of the pipette tip increases a portion of a dispensed liquid that flows in a non-vertical direction (e.g., in a diagonal direction), thereby reducing disruption of cells or particles located toward a bottom of a liquid container.

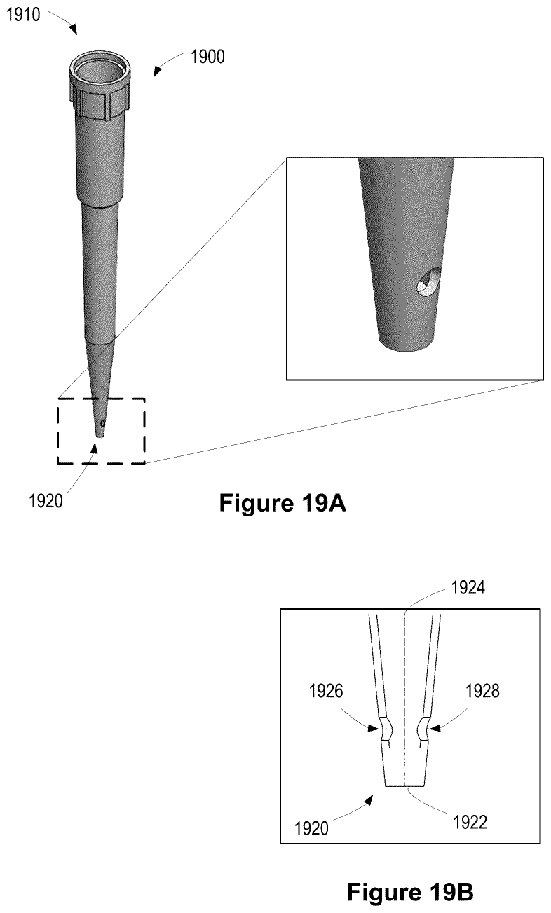

FIG. 19A illustrates a pipette tip 1900 in accordance with some embodiments. The pipette tip 1900 includes a tube (or a tubular structure) having a first end portion 1910 and a second end portion 1920 opposite to the first end portion 1910. Similar to the pipette tip 1800 described with respect to FIG. 18A, the first end portion 1910 is characterized by a first inner diameter and the second end portion 1920 is characterized by a second inner diameter less than the first inner diameter (e.g., the first end portion 1910 has a larger inner diameter than the second end portion 1920).

FIG. 19A also illustrates an enlarged view of the second end portion 1920 of the pipette tip 1900.

FIG. 19B shows a cross-sectional view of the second end portion 1920 of the pipette tip 1900 taken along a plane encompassing an axis of the pipette tip 1900 (e.g., a view taken from a center cut of the pipette tip 1900). Unlike the pipette tip 1800 shown in FIG. 18B, a tip 1922 of the second end portion 1920 is enclosed along a direction 1924 of the tube (e.g., along a vertical direction in FIG. 19B). Instead, one or more side holes (e.g., side holder 1926 and 1928) are defined in the second end portion 1920 of the pipette tip 1900.

### Non-Vertical Movement of Liquid Transferrers

In some embodiments, an apparatus (e.g., a liquid handling system) includes one or more actuators for moving one or more liquid dispensers in a non-vertical direction while the one or more liquid transferrer dispense or aspirate liquid. In some configurations, this facilitates mixing of a liquid dispensed from the liquid transferrer into an existing liquid in a liquid container. In addition, this also induces a rotational liquid flow during aspiration of a liquid, which also facilitates mixing of a solution in the liquid container.

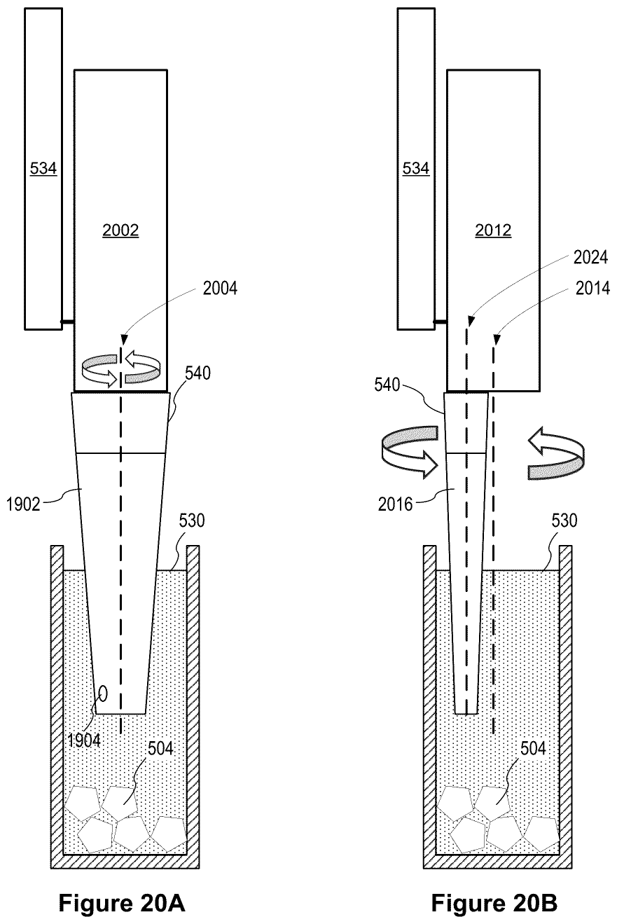

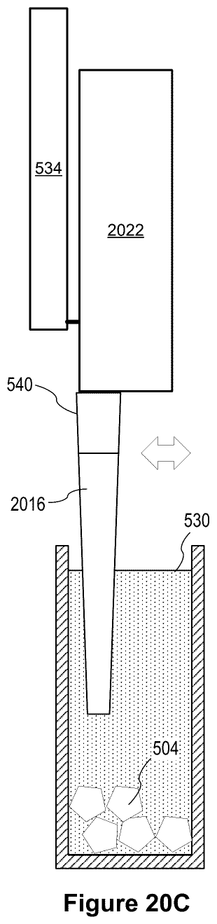

FIG. 20A illustrates an apparatus with an actuator 2002 for rotating a pipette tip 1902 on-axis in accordance with some embodiments. The actuator 2002 rotates the pipette tip 1902 (by rotating the liquid transferrer 540 coupled with a pipette tip 1902) along an axis 2004 defined by the pipette tip 1902 or the liquid transferrer 540. When the pipette tip 1902 with one or more side holes 1904 are mounted on the liquid transferrer 540, the actuator 2002 facilitates distribution of liquid dispensed from the liquid transferrer 540, thereby enhancing mixing of a sample solution and a dispensed liquid.

FIG. 20B illustrates an apparatus with an actuator 2012 for rotating a pipette tip 2016 off-axis in accordance with some embodiments. The actuator 2012 rotates the pipette tip 2016 along an axis 2014 that is offset from an axis 2024 defined by the pipette tip 2016 or the liquid transferrer 540. This induces a stirring movement with the pipette tip 2016, thereby facilitating mixing of the liquid in the liquid container.

FIG. 20C illustrates an apparatus with an actuator 2022 for moving a pipette tip 2016 laterally in accordance with some embodiments. In some embodiments, the actuator 2022 reciprocates the lateral movement of the pipette tip 2016. This facilitates mixing of the liquid in the liquid container.

### Certain Methods

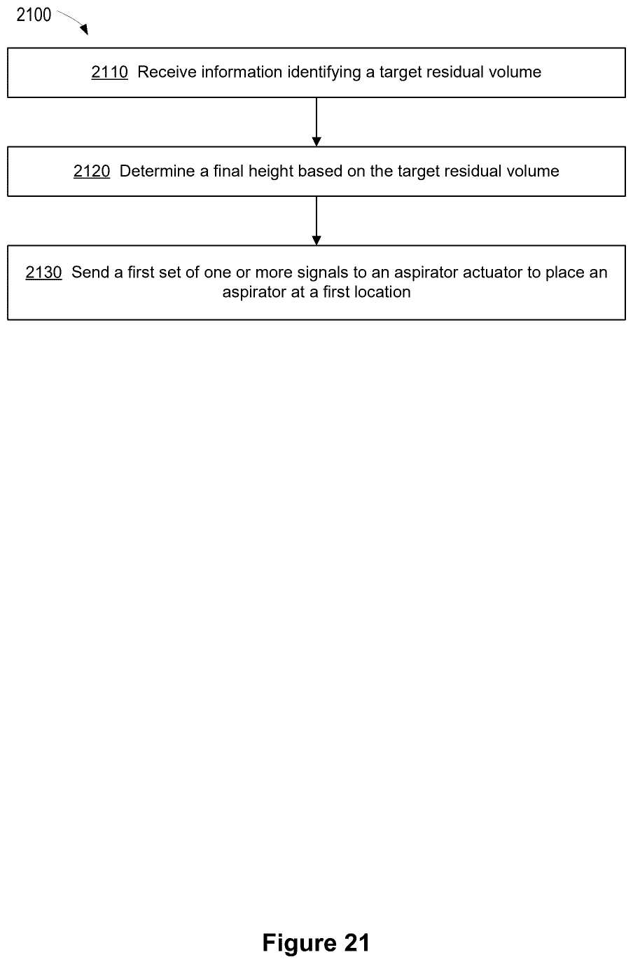

FIG. 21 is a flow diagram illustrating a method 2100 of determining a height of an aspirator based on a volume in accordance with some embodiments.

The method 2100 is performed by an electronic device (e.g., the liquid handling system 300 or an electronic controller including one or more processors 480 and memory 482) in communication with an aspirator actuator coupled with an aspirator.

The method includes (2110) receiving information identifying a target residual volume. In some embodiments, the method includes retrieving the information identifying the target residual volume from a data structure (e.g., the data structure 1100). For example, a predefined protocol may identify the target residual volume for a washing operation.

The method includes (2120) determining a final height based on the target residual volume.

In some embodiments, determining the final height includes identifying a height value from a lookup table (e.g., lookup table 1200) using the target residual volume.

In some embodiments, the lookup table include a height value for a target residual volume of about 20 μL. In some embodiments, the lookup table include a height value for a target residual volume of about 30 μL. In some embodiments, the lookup table include a height value for a target residual volume of about 225 μL. In some embodiments, the lookup table include a height value for a target residual volume of about 955 μL.

In some embodiments, the target residual volume is defined as a portion of a total volume of a liquid container. For example, in some embodiments, the information 1202 identifying the liquid container identifies a size or total volume of the liquid container. In some embodiments, the total volume of the liquid container is identified based on the information 1202 identifying the liquid container. For example, a typical total volume of a well in a 96-well round bottom microplate is between 200 and 300 μl; a typical total volume of a well in a deep well plate is between 1.2 and 2 ml; a typical total volume of a tube is between 5 and 15 ml. In some embodiments, the target residual volume is defined as 1%, 10%, or 50% of the total volume of the liquid container.

The method includes (2130) sending a first set of one or more signals to the aspirator actuator to place the aspirator at a first location.

In some embodiments, the aspirator is located adjacent to a well. Placing the aspirator at a first location causes a nozzle of the aspirator to be located at the final height (e.g., Ha1) above a bottom of the well (e.g., FIG. 5C).

In some embodiments, the method also includes sending one or more signals to cause the aspirator to aspirate liquid at least partly at the first location.

FIG. 22 is a flow diagram illustrating a method 2200 of determining a height of a dispenser based on a volume in accordance with some embodiments.

The method 2200 is performed by an electronic device (e.g., the liquid handling system 300 or an electronic controller including one or more processors 480 and memory 482) in communication with a dispenser actuator coupled with a dispenser.

The method includes (2210) receiving information identifying a target residual volume. In some embodiments, the method includes retrieving the information identifying the target residual volume from a data structure (e.g., the data structure 1100). For example, a predefined protocol may identify the target residual volume for a washing operation.

The method includes (2220) determining a final height based on the target residual volume.

The method includes (2230) sending a first set of one or more signals to the dispenser actuator to place the dispenser at a first location.

In some embodiments, the dispenser is located adjacent to a well. Placing the dispenser at a first location causes a nozzle of the dispenser to be located at the final height (e.g., Hd1) above a bottom of the well (e.g., FIG. 7B).

In some embodiments, the method also includes sending one or more signals to cause the aspirator to aspirate liquid at least partly at the first location.

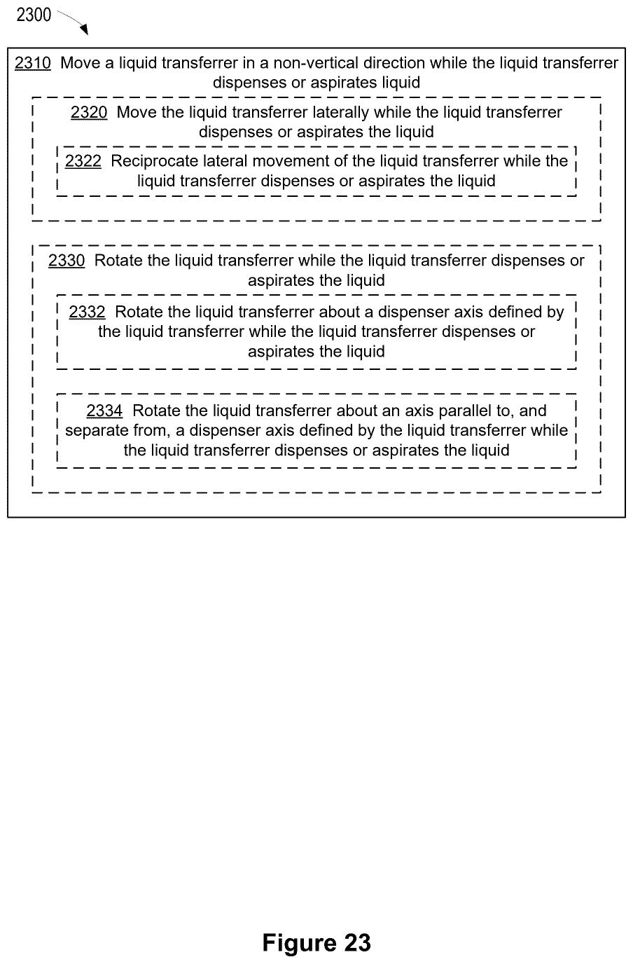

FIG. 23 is a flow diagram illustrating a method 2300 of moving a liquid transferrer in a non-vertical direction in accordance with some embodiments.

The method 2300 is performed by an electronic device (e.g., the liquid handling system 300 or an electronic controller including one or more processors 480 and memory 482) in communication with one or more actuators coupled with a liquid transferrer (e.g., a dispenser or an aspirator or an integrated dispenser-aspirator).

The method includes (2310) moving the liquid transferrer in a non-vertical direction while the liquid transferrer dispenses or aspirates liquid.

In some embodiments, the method includes (2320) moving the liquid transferrer laterally while the liquid transferrer dispenses or aspirates the liquid (e.g., FIG. 20C). In some embodiments, the method includes (2322) reciprocating the lateral movement of the liquid transferrer while the liquid transferrer dispenses or aspirates the liquid.

In some embodiments, the method includes (2330) rotating the liquid transferrer while the liquid transferrer dispenses or aspirates the liquid (e.g., FIGS. 20A and 20B). In some embodiments, the method includes (2332) rotating the liquid transferrer about a transferrer axis defined by the liquid transferrer while the liquid transferrer dispenses or aspirates the liquid (e.g., FIG. 20A). In some embodiments, the method includes (2324) rotating the liquid transferrer about an axis (e.g., axis 2014) parallel to, and separate from, a transferrer axis (e.g., axis 2024) defined by the liquid transferrer while the liquid transferrer dispenses or aspirates the liquid (e.g., FIG. 20B).

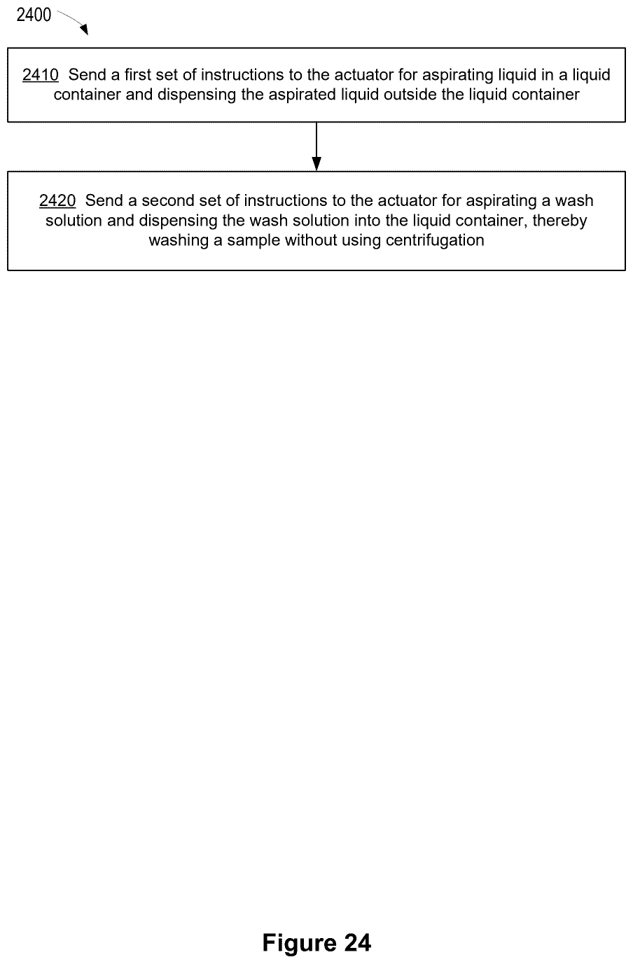

FIG. 24 is a flow diagram illustrating a method 2400 of controlling an actuator for washing a sample without using centrifugation in accordance with some embodiments.

The method 2400 is performed by an electronic device (e.g., the liquid handling system 300 or an electronic controller including one or more processors 480 and memory 482) in communication with an actuator coupled with one or more liquid transferrers.

The method includes (2410) sending a first set of instructions to the actuator for aspirating liquid in a liquid container (e.g., a plate with a plurality of wells or any other type of a container for containing liquid) and dispensing the aspirated liquid outside the liquid container. For example, the first set of instructions causes the liquid handling system 300 to (i) place the liquid transferrer 312 above the liquid container so that a tip of the liquid transferrer 312 is in contact with a sample solution while the liquid transferrer 312 aspirates a portion of the sample solution (e.g., FIGS. 5A-5C), and (ii) subsequently place the liquid transferrer 312 away from the liquid container (e.g., above a waste reservoir) so that the aspirated portion of the sample solution is dispensed (e.g., discarded) outside the liquid container (e.g., into the waste reservoir).

The method also includes (2420) sending a second set of instructions to the actuator for aspirating a wash solution and dispensing the wash solution into the liquid container, thereby washing a sample without using centrifugation. For example, the second set of instructions causes the liquid handling system 300 to (i) place the liquid transferrer 312 above a reservoir of the wash solution so that the liquid transferrer 312 aspirates the wash solution and (ii) subsequently place the liquid transferrer 312 above the liquid container so that the liquid transferrer 312 dispenses the wash solution into the liquid container (e.g., FIGS. 7A-7C).

In some embodiments, the wash solution is dispensed below a predefined flow rate (e.g., 5-20 μL/s). This allows the wash solution to be output while reducing disturbance of settled particles (e.g., cells and/or beads) within the liquid container, thereby increasing the percentage of retained cells and/or beads. In addition, this reduces the need for a long settling time, thereby improving the overall throughput of the washing operation.

In some embodiments, the method also includes, subsequent to sending the second set of instructions to the actuator, sending the first set of instructions to the actuator for aspirating the liquid in the liquid container (e.g., a plate with a plurality of wells or any other type of a container for containing liquid) and dispensing the aspirated liquid outside the liquid container.

In some embodiments, the electronic device (e.g., the liquid handling system 300) includes a temperature controller for adjusting a temperature for incubation. The method also includes sending a third set of instructions to the temperature controller for incubating a liquid container at a predefined temperature.

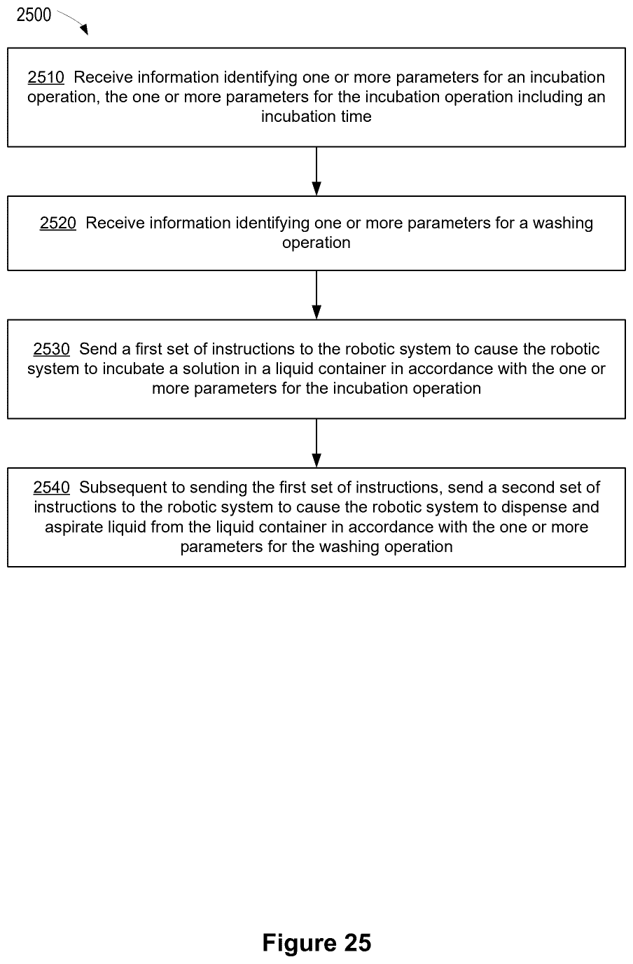

FIG. 25 is a flow diagram illustrating a method 2500 of controlling a robotic system for washing operation in accordance with some embodiments.

The method 2500 is performed by an electronic device (e.g., an electronic controller including one or more processors 480 and memory 482) in communication with a robotic system (e.g., the liquid handling system 300) including a liquid transferrer.

The method includes (2510) receiving information identifying one or more parameters for an incubation operation (e.g., information 1112 and/or 1114), the one or more parameters for the incubation operation including an incubation time (e.g., information 1112).

The method includes (2520) receiving information identifying one or more parameters for a washing operation (e.g., information 1122, 1124, 1126, 1128, 1130, or a subset thereof).

The method includes (2530) sending a first set of instructions to the robotic system to cause the robotic system to incubate a solution in a liquid container in accordance with the one or more parameters for the incubation operation. In some embodiments, the robotic system, in response to receiving the first set of instructions, incubates the solution in the liquid container (e.g., the robotic system includes a temperature controller and the robotic system activates the temperature controller to adjust the temperature of the solution in the liquid container to the incubation temperature identified by information 1114 during the incubation time identified by information 1112).

The method includes (2540) includes subsequent to sending the first set of instructions, sending a second set of instructions to the robotic system to cause the robotic system to dispense and aspirate liquid from the liquid container in accordance with the one or more parameters for the washing operation. In some embodiments, the robotic system, in response to receiving the second set of instructions, performs the washing operation based on the parameters identified by information 1122, 1124, 1126, 1128, 1130, or a subset thereof.

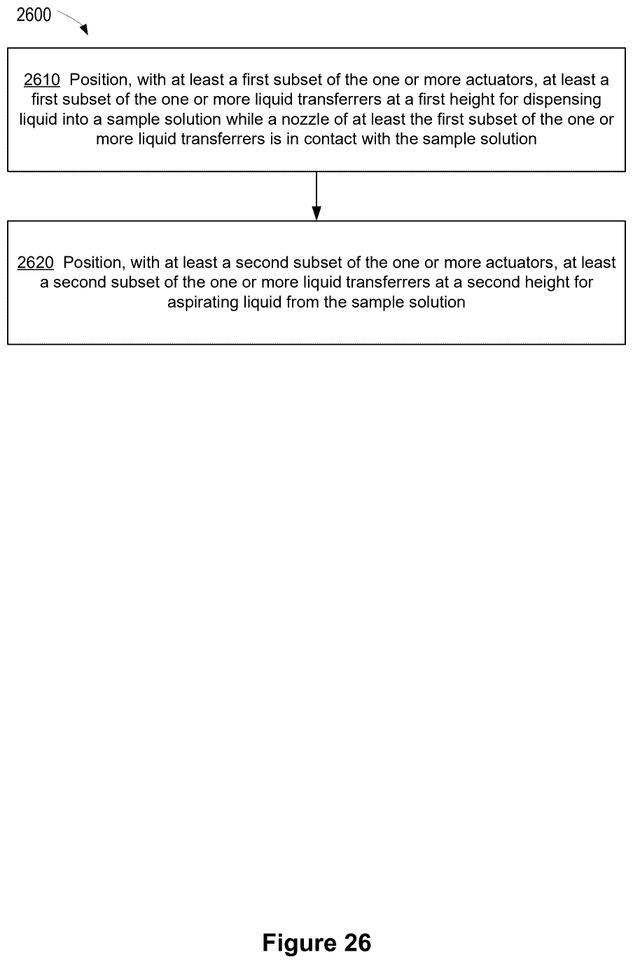

FIG. 26 is a flow diagram illustrating a method 2600 of washing a sample without using centrifugation in accordance with some embodiments.

The method 2600 is performed by an apparatus (e.g., the liquid handling system 300) that includes one or more liquid transferrers and one or more actuators coupled with the one or more liquid transferrers for washing a sample.

The method includes (2610) positioning, with at least a first subset of the one or more actuators, at least a first subset of the one or more liquid transferrers at a first height (e.g., Hd1) for dispensing liquid into a sample solution while a nozzle of at least the first subset of the one or more liquid transferrers is in contact with the sample solution (e.g., FIG. 7B).

In some embodiments, the liquid is dispensed into the sample solution at a flow rate between 5 and 10 μL/s while at least the first subset of the one or more liquid transferrers is positioned at the first height.

The method includes (2620) positioning, with at least a second subset of the one or more actuators, at least a second subset of the one or more liquid transferrers at a second height (e.g., Ha1) for aspirating liquid from the sample solution. In some embodiments, the liquid from the sample solution is aspirated while a nozzle of at least the second subset of the one or more liquid transferrers is in contact with the sample solution (e.g., FIG. 5C).

In some embodiments, the liquid from the sample solution is aspirated at a flow rate between 5 and 10 μL/s (e.g., while at least the second subset of the one or more liquid transferrers is positioned at the second height or while at least the second subset of the one or more liquid transferrers is positioned at a lowest height for the aspiration operation).

In some embodiments, the method includes maintaining the first subset of the one or more liquid transferrers at the first height (e.g., Hd1) while the first subset of the one or more liquid transferrers dispenses liquid into the sample solution. In some embodiments, the method includes maintaining the second subset of the one or more liquid transferrers at the second height (e.g., Ha1) while the second subset of the one or more liquid transferrers aspirate liquid from the sample solution. In some embodiments, the method includes maintaining the first subset of the one or more liquid transferrers at the first height (e.g., Hd1) while the first subset of the one or more liquid transferrers dispenses liquid into the sample solution; and maintaining the second subset of the one or more liquid transferrers at the second height (e.g., Ha1) while the second subset of the one or more liquid transferrers aspirate liquid from the sample solution.

In some embodiments, the method includes changing a height of at least one liquid transferrer during at least one of: the dispensing or the aspirating.

In some embodiments, the method includes positioning a first liquid transferrer at the first height for dispensing liquid into the sample solution from the first liquid transferrer; positioning the first liquid transferrer at the second height for aspirating liquid from the sample solution with the first liquid transferrer; and changing the height of the first liquid transferrer during at least one of the dispensing or the aspirating.

In some embodiments, the method includes changing (e.g., increasing) the height of the first liquid transferrer during the dispensing; and changing (e.g., decreasing) the height of the first liquid transferrer during the aspirating.

In some embodiments, the method includes changing (e.g., increasing) the height of the first liquid transferrer during the dispensing; and maintaining the height of the first liquid transferrer during the aspirating.

In some embodiments, the method includes maintaining the height of the first liquid transferrer during the dispensing; and changing (e.g., decreasing) the height of the first liquid transferrer during the aspirating.

In some embodiments, the method includes positioning the first dispenser at the first height for dispensing liquid into the sample solution from the first liquid transferrer; positioning the first aspirator at the second height for aspirating liquid from the sample solution with the first liquid transferrer; and at least one of: changing the height of the first dispenser during the dispensing or changing the height of the first aspirator during the aspirating.

In some embodiments, the method includes changing (e.g., increasing) the height of the first dispenser during the dispensing; and changing (e.g., decreasing) the height of the first aspirator during the aspirating.

In some embodiments, the method includes changing (e.g., increasing) the height of the first dispenser during the dispensing; and maintaining the height of the first aspirator during the aspirating.

In some embodiments, the method includes maintaining the height of the first dispenser during the dispensing; and changing (e.g., decreasing) the height of the first aspirator during the aspirating.

In some embodiments, the first height is between 1 mm and 10 mm. In some embodiments, the second height is between 1 mm and 10 mm. In some embodiments, the first height is between 1.5 mm and 3 mm. In some embodiments, the second height is between 1.5 mm and 3 mm. In some embodiments, the first height is approximately 2 mm. In some embodiments, the second height is approximately 2 mm.

In some embodiments, the method includes, prior to positioning at least the first subset of the one or more liquid transferrers at the first height for dispensing liquid into the sample solution, positioning at least the second subset of the one or more liquid transferrers at the second height for aspirating liquid from the sample solution.

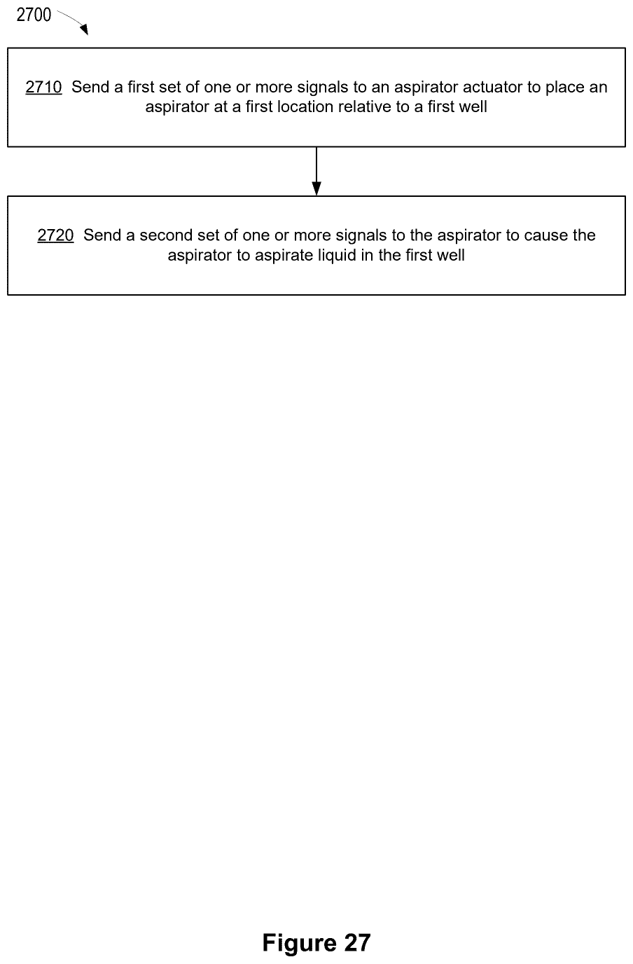

FIG. 27 is a flow diagram illustrating a method 2700 of aspirating liquid in accordance with some embodiments.

The method 2700 is performed by an electronic device (e.g., the liquid handling system 300 or an electronic controller including one or more processors 480 and memory 482) in communication with an aspirator actuator and an aspirator coupled with the aspirator actuator.

The method includes (2710) sending a first set of one or more signals to the aspirator actuator to place the aspirator at a first location relative to a first well.

The method also includes (2720) sending a second set of one or more signals to the aspirator to cause the aspirator to aspirate liquid in the first well.

In some embodiments, the method also includes identifying the first set of one or more signals based on information identifying a shape of the first well.

In some embodiments, the first location is determined relative to a bottom of the first well.

In some embodiments, the first location is determined relative to a top surface of the liquid in the first well.

In some embodiments, the method also includes determining a height of the liquid in the first well.

In some embodiments, the height of the liquid is determined from a volume of the liquid (e.g., 30-100 μL) in the first well.

In some embodiments, a tip of the aspirator is located adjacent to a top surface of the liquid in the first well.

In some embodiments, the method also includes sending a third set of one or more signals to the aspirator actuator to move the aspirator while the aspirator aspirates the liquid.

In some embodiments, the method also includes sending a fourth set of one or more signals to the aspirator to change a rate of aspiration based on a location of the aspirator.

In some embodiments, the first well defines a longitudinal axis (e.g., a vertical axis); and the first set of one or more signals identifies a position along the longitudinal axis only.

In some embodiments, the first well defines a longitudinal axis (e.g., a vertical axis); and the first set of one or more signals identifies (i) a position along the longitudinal axis and (ii) one or more distances from the longitudinal axis in one or more directions non-parallel to the longitudinal axis.

In some embodiments, the electronic device is also in communication with a dispenser actuator and a dispenser coupled with the dispenser actuator. The method includes sending a fifth set of one or more signals to the dispenser actuator to place the dispenser at a second location relative to the first well; and sending a sixth set of one or more signals to the dispenser to cause the dispenser to dispense a wash liquid in the first well.

In some embodiments, the method also includes identifying the fifth set of one or more signals based on information identifying a shape of the first well.

In some embodiments, the second location is determined relative to a bottom of the first well.

In some embodiments, the second location is determined relative to a top surface of the liquid in the first well.

In some embodiments, the method also includes determining a height of the liquid in the first well.

In some embodiments, the height of the liquid is determined from a volume of the liquid (e.g., 30-100 μL) in the first well.

In some embodiments, a tip of the dispenser is located adjacent to a top surface of the liquid in the first well.

In some embodiments, the method also includes sending a seventh set of one or more signals to the dispenser actuator to move the dispenser while the dispenser dispenses the liquid.

In some embodiments, the method also includes sending an eighth set of one or more signals to the dispenser to change a rate of dispensing based on a location of the dispenser.

In some embodiments, the first well defines a longitudinal axis (e.g., a vertical axis); and the fifth set of one or more signals identifies a position along the longitudinal axis only.

In some embodiments, the first well defines a longitudinal axis (e.g., a vertical axis); and the fifth set of one or more signals identifies (i) a position along the longitudinal axis and (ii) one or more distances from the longitudinal axis in one or more directions non-parallel to the longitudinal axis.

In some embodiments, the one or more directions include a first direction and a second direction non-parallel to the first direction.

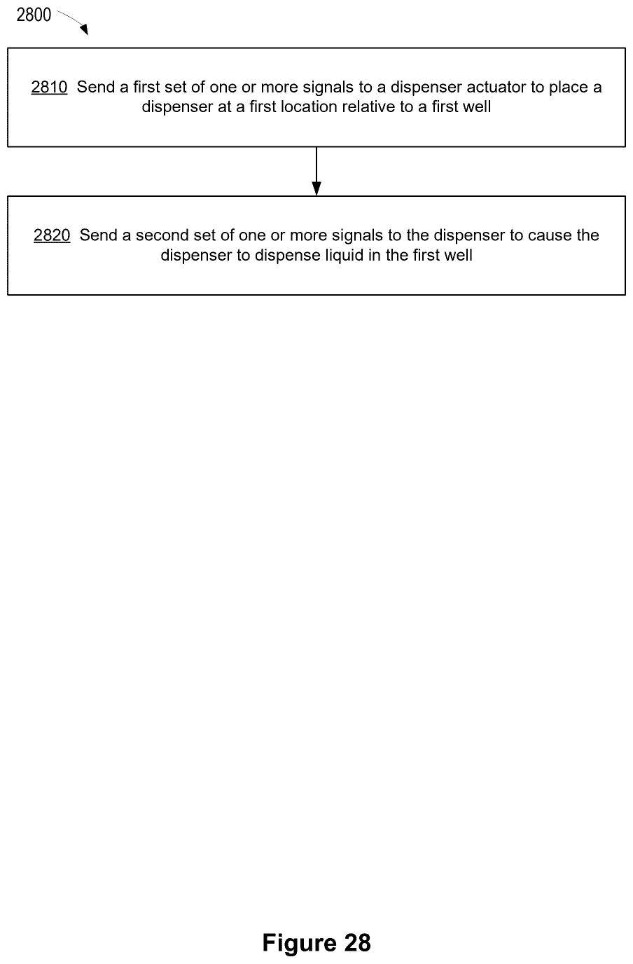

FIG. 28 is a flow diagram illustrating a method 2800 of dispensing liquid in accordance with some embodiments.

The method 2800 is performed by an electronic device (e.g., the liquid handling system 300 or an electronic controller including one or more processors 480 and memory 482) in communication with a dispenser actuator and a dispenser coupled with the dispenser actuator.

The method includes (2810) sending a first set of one or more signals to the dispenser actuator to place the dispenser at a first location relative to a first well.

The method also includes (2820) sending a second set of one or more signals to the dispenser to cause the dispenser to dispense a wash liquid in the first well.

In some embodiments, the method also includes identifying the first set of one or more signals based on information identifying a shape of the first well.

In some embodiments, the first location is determined relative to a bottom of the first well.

In some embodiments, the first location is determined relative to a top surface of the liquid in the first well.

In some embodiments, the method also includes determining a height of the liquid in the first well.

In some embodiments, the height of the liquid is determined from a volume of the liquid (e.g., 30-100 μL) in the first well.

In some embodiments, a tip of the dispenser is located adjacent to a top surface of the liquid in the first well.

In some embodiments, the method also includes sending a seventh set of one or more signals to the dispenser actuator to move the dispenser while the dispenser dispenses the liquid.

In some embodiments, the method also includes sending an eighth set of one or more signals to the dispenser to change a rate of dispensing based on a location of the dispenser.

In some embodiments, the first well defines a longitudinal axis (e.g., a vertical axis); and the first set of one or more signals identifies a position along the longitudinal axis only.

In some embodiments, the first well defines a longitudinal axis (e.g., a vertical axis); and the first set of one or more signals identifies (i) a position along the longitudinal axis and (ii) one or more distances from the longitudinal axis in one or more directions non-parallel to the longitudinal axis.

In some embodiments, the one or more directions include a first direction and a second direction non-parallel to the first direction.

In light of these principles and examples, we now turn to certain embodiments.

In accordance with some embodiments, a device (e.g., device 1400) includes a block (e.g., block 1410) defining a plurality of through-holes (e.g., through-holes 1422, 1424, 1426). A respective through-hole of the plurality of through-holes is configured to fit with an outside of a pipette tip (e.g., FIG. 14B).

In some embodiments, the respective through-hole of the plurality of through-holes defines a respective axis (e.g., axes 1432, 1434, and 1436); and the respective axes defined by the plurality of through-holes are substantially parallel to one another.

In some embodiments, the plurality of through-holes has substantially the same spacing between two adjacent through-holes of the plurality of through-holes.

In some embodiments, at least a portion of a side wall of the respective through-hole of the plurality of through-holes has a predefined slope (e.g., sloped portion 1440).

In some embodiments, one or more ribs are defined on a side wall of the respective through-hole of the plurality of through-holes (e.g., ribs 1442).

In some embodiments, a side wall of the respective through-hole of the plurality of through-holes is free from one or more ribs (e.g., FIG. 15A).

In some embodiments, the device includes a lower block (e.g., lower block 1720) defining a first plurality of through-holes characterized by an inner diameter less than a largest outer diameter of the pipette tip; and an upper block (e.g., upper block 1730) distinct from the lower block and defining a second plurality of through-holes characterized by an inner diameter less than the largest outer diameter of the pipette tip. A respective through-hole of the first plurality of through-holes is aligned with a corresponding through-hole of the second plurality of through-holes. Either the respective through-hole of the first plurality of through-holes or the corresponding through-hole of the second plurality of through-holes has a portion (e.g., 1732) with an inner diameter greater than the largest outer diameter of the pipette tip.

In accordance with some embodiments, a pipette tip (e.g., pipette tip 1800) includes a tube having a first end portion (e.g., first end portion 1810) and a second end portion (e.g., second end portion 1820) opposite to the first end portion. The first end portion is characterized by a first inner diameter (e.g., I1) and the second end portion is characterized by a second inner diameter (e.g., I2) less than the first inner diameter. The second end portion includes a first region (e.g., 1822) located at a tip of the second end portion and a second region (e.g., 1824) located away from the tip of the second end portion. The first region is characterized by the second inner diameter (e.g., I2) and the second region is characterized by a third inner diameter (e.g., I3) less than the second inner diameter.

In accordance with some embodiments, a pipette tip (e.g., pipette tip 1900) includes a tube having a first end portion (e.g., first end portion 1910) and a second end portion (e.g., second end portion 1920) opposite to the first end portion. The first end portion is characterized by a first inner diameter and the second end portion is characterized by a second inner diameter less than the first inner diameter. A tip of the second end portion is enclosed along a direction of the tube (e.g., closed tip 1922). The second end portion defines one or more side holes (e.g., side holes 1926 and 1928). In some embodiments, the one or more side holes are located within 2 mm from the tip of the second end portion.

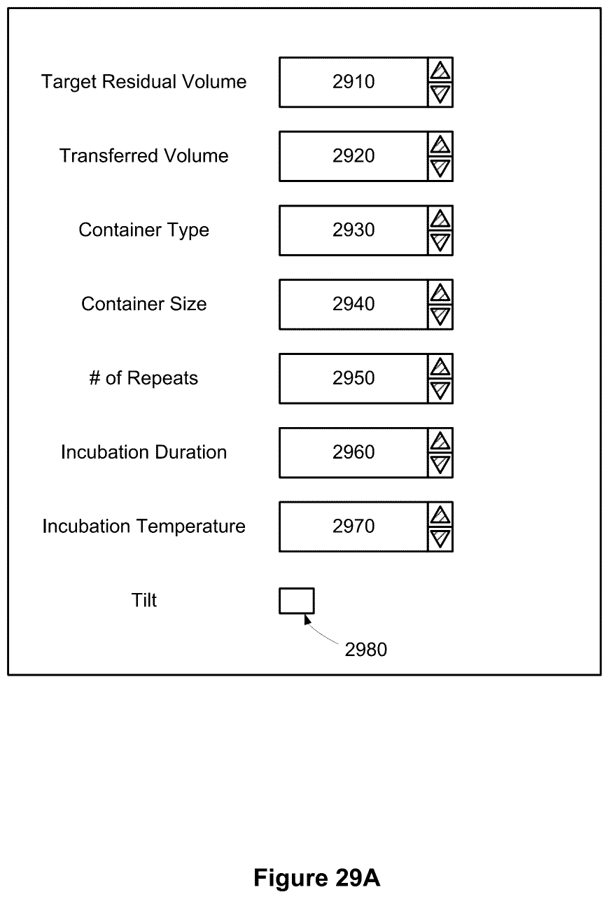

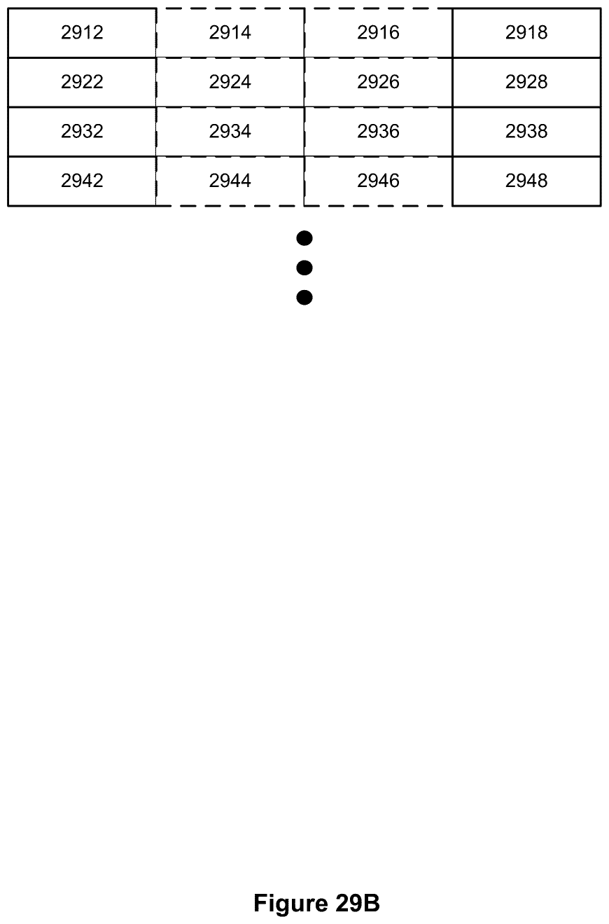

FIG. 29A illustrates a graphical user interface for receiving parameters for an incubation operation in accordance with some embodiments.

The graphical user interface includes one or more user interface objects for receiving parameters for various operations. In some embodiments, the one or more user interface objects include the following, or a subset or superset thereof:
user interface object 2910 for receiving a target residual (liquid) volume;
user interface object 2920 for receiving a transferred (liquid) volume;
user interface object 2930 for receiving a container type (e.g., a well plate or a tube, with or without a specific size);
user interface object 2940 for receiving a container size (e.g., a number of wells and/or a volume of the container);
user interface object 2950 for receiving a number of repeats for washing operations (e.g., dispensing and aspiration, or aspiration and dispensing);
user interface object 2960 for receiving an incubation duration;
user interface object 2970 for receiving an incubation temperature; and
user interface object 2980 for receiving whether to tilt the container (e.g., during incubation and/or during washing operations).

FIG. 29B illustrates a data structure (e.g., lookup table) for determining a liquid height in accordance with some embodiments. FIG. 29B shows that the data structure includes target residual volume values (e.g., 2912, 2922, 2932, 2942) and corresponding height values, such as final aspiration height values (e.g., 2918, 2928, 2938, 2948). Thus, the data structure allows determination of a final aspiration height from a target residual volume.

In some embodiments, the data structure also includes information identifying a container type (e.g., 2914, 2924, 2934, 2944) or information identifying a container size (e.g., 2916, 2926, 2936, 2946) or both. In some embodiments, the final aspiration height is determined also based on the container type and/or the container size in addition to the target residual volume (e.g., by looking up a final aspiration height that corresponds to an identified target residual volume, an identified container type, and an identified container size).

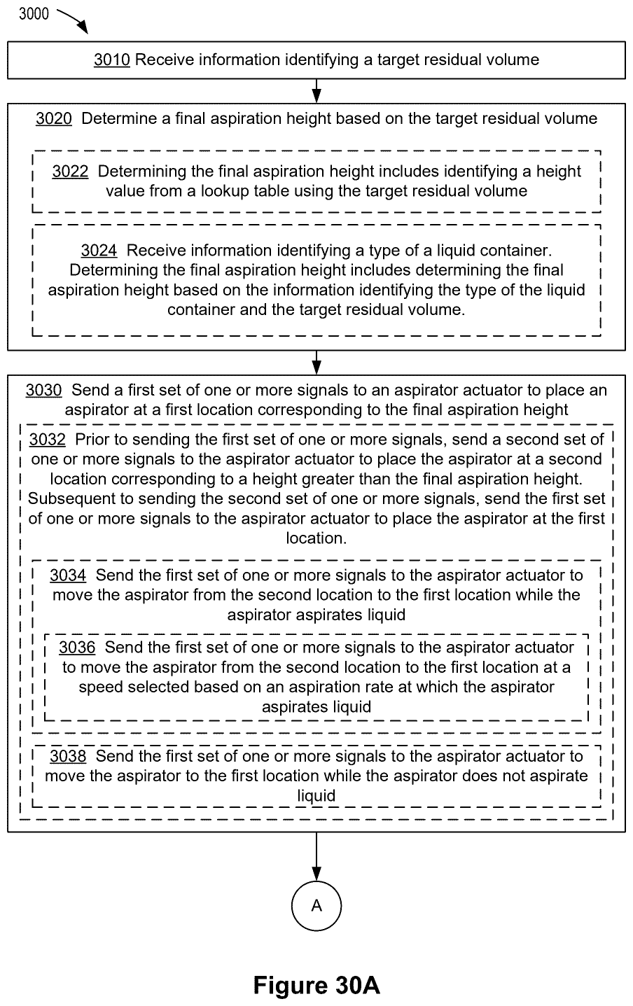

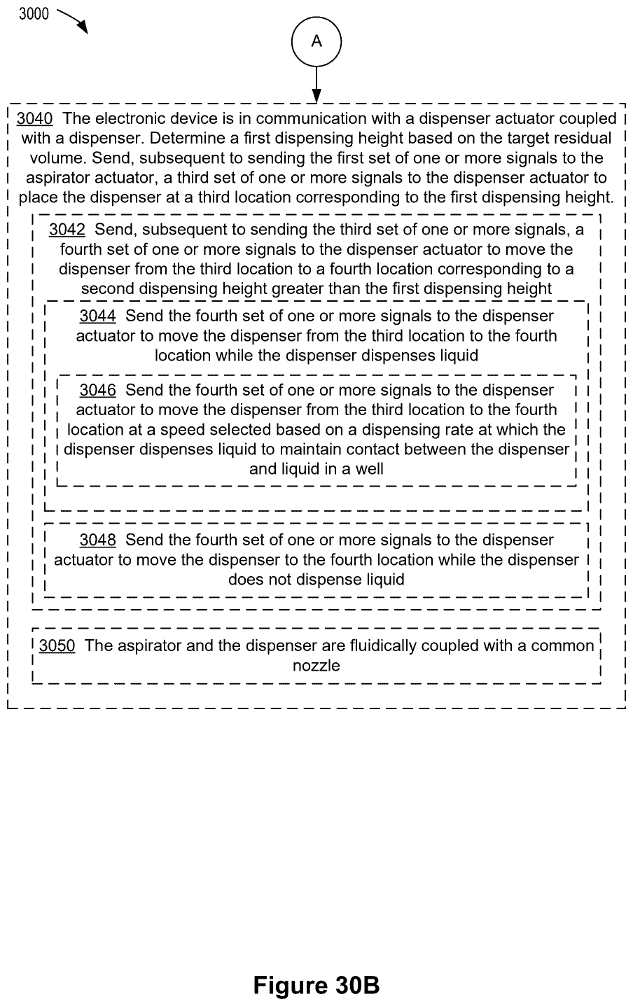

FIGS. 30A and 30B are flow diagrams illustrating operations carried out by one or more processors (e.g., 480) of an electronic device (e.g., FIG. 4) for operating an aspirator in accordance with some embodiments.

The one or more processors (3010) receive information identifying a target residual volume.

The one or more processors (3020) determine a final aspiration height based on the target residual volume.

In some embodiments, determining the final aspiration height includes (3022) identifying a height value from a lookup table using the target residual volume.

In some embodiments, the lookup table include a height value for a target residual volume of about 30 μL, about 50 μL, or about 70 μL. In some embodiments, the lookup table include a height value for a target residual volume of about 30 μL, about 50 μL, and about 70 μL.

In some embodiments, the one or more processors (3024) receive information identifying a type of a liquid container. Determining the final aspiration height includes determining the final aspiration height based on the information identifying the type of the liquid container and the target residual volume.

The one or more processors (3030) send a first set of one or more signals to the aspirator actuator to place the aspirator at a first location corresponding to the final aspiration height.

In some embodiments, the aspirator is located adjacent to a well. Placing the aspirator at the first location causes a nozzle of the aspirator to be located at the final aspiration height above a bottom of the well.

In some embodiments, the one or more processors, prior to sending the first set of one or more signals, (3032) send a second set of one or more signals to the aspirator actuator to place the aspirator at a second location corresponding to a height greater than the final aspiration height; and subsequent to sending the second set of one or more signals, send the first set of one or more signals to the aspirator actuator to place the aspirator at the first location.

In some embodiments, the one or more processors (3034) send the first set of one or more signals to the aspirator actuator to move the aspirator from the second location to the first location while the aspirator aspirates liquid.

In some embodiments, the one or more processors (3036) send the first set of one or more signals to the aspirator actuator to move the aspirator from the second location to the first location at a speed selected based on an aspiration rate at which the aspirator aspirates liquid.

In some embodiments, the one or more processors (3038) send the first set of one or more signals to the aspirator actuator to move the aspirator to the first location while the aspirator does not aspirate liquid.

In some embodiments, the electronic device is in communication with a dispenser actuator coupled with a dispenser. In some embodiments, the one or more processors (3040) determine a first dispensing height based on the target residual volume; and send, subsequent to sending the first set of one or more signals to the aspirator actuator, a third set of one or more signals to the dispenser actuator to place the dispenser at a third location corresponding to the first dispensing height.

In some embodiments, the one or more processors (3042) send, subsequent to sending the third set of one or more signals, a fourth set of one or more signals to the dispenser actuator to move the dispenser from the third location to a fourth location corresponding to a second dispensing height greater than the first dispensing height.

In some embodiments, the one or more processors (3044) send the fourth set of one or more signals to the dispenser actuator to move the dispenser from the third location to the fourth location while the dispenser dispenses liquid.

In some embodiments, the one or more processors (3046) send the fourth set of one or more signals to the dispenser actuator to move the dispenser from the third location to the fourth location at a speed selected based on a dispensing rate at which the dispenser dispenses liquid to maintain contact between the dispenser and liquid in a well.

In some embodiments, the one or more processors (3048) send the fourth set of one or more signals to the dispenser actuator to move the dispenser to the fourth location while the dispenser does not dispense liquid.

In some embodiments, the aspirator and the dispenser are fluidically coupled with a common nozzle.

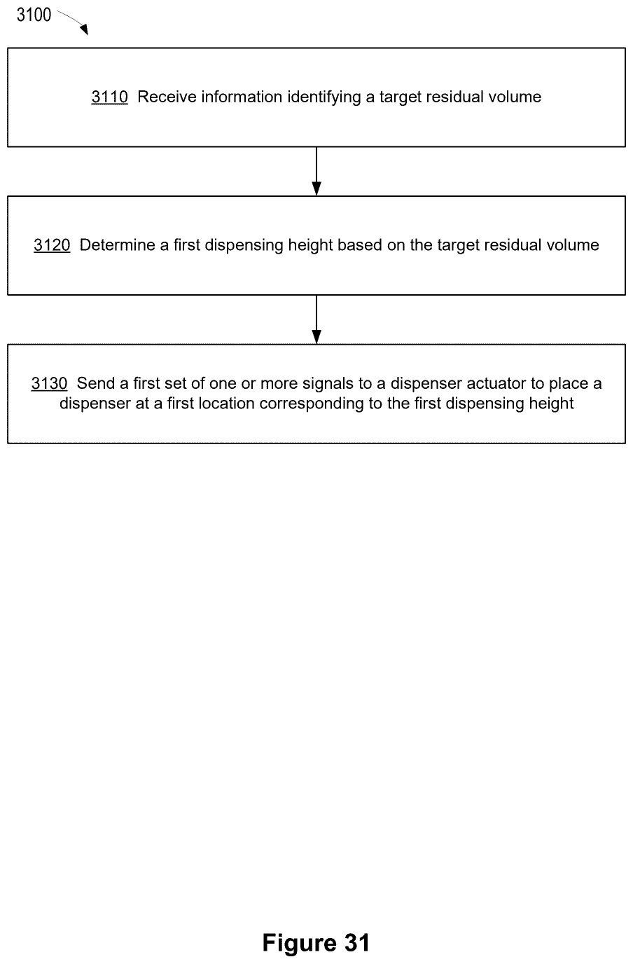

FIG. 31 is a flow diagram illustrating operations carried out by one or more processors of an electronic device for operating a dispenser in accordance with some embodiments.

The one or more processors (3110) receive information identifying a target residual volume; (3120) determine a first dispensing height based on the target residual volume; and (3130) send a first set of one or more signals to the dispenser actuator to place the dispenser at a first location corresponding to the first dispensing height.

In some embodiments, the dispenser is located adjacent to a well. Placing the dispenser at the first location causes a nozzle of the dispenser to be located at the first dispensing height above a bottom of the well.

In some embodiments, determining the initial dispensing height includes identifying a height value from a lookup table using the target residual volume.

In some embodiments, the lookup table include a height value for a target residual volume of about 30 μL, about 50 μL, or about 70 μL. In some embodiments, the lookup table include a height value for a target residual volume of about 30 μL, about 50 μL, and about 70 μL.

In some embodiments, the one or more processors receive information identifying a type of a liquid container. Determining the initial dispensing height includes determining the initial dispensing height based on the information identifying the type of the liquid container and the target residual volume.

In some embodiments, the one or more processors, subsequent to sending the first set of one or more signals, send a second set of one or more signals to the dispenser actuator to place the dispenser at a second location corresponding to a height greater than the initial dispensing height.

In some embodiments, the one or more processors send the second set of one or more signals to the dispenser actuator to move the dispenser from the first location to the second location while the dispenser dispenses liquid.

In some embodiments, the one or more processors send the second set of one or more signals to the dispenser actuator to move the dispenser from the first location to the second location at a speed selected based on a dispensing rate at which the dispenser dispenses liquid.

In some embodiments, the electronic device is in communication with an aspirator actuator coupled with an aspirator. In some embodiments, the one or more processors determine a final aspiration height based on the target residual volume; and send, subsequent to sending the first set of one or more signals to the dispenser actuator, a third set of one or more signals to the aspirator actuator to place the aspirator at a third location corresponding to the final aspiration height.

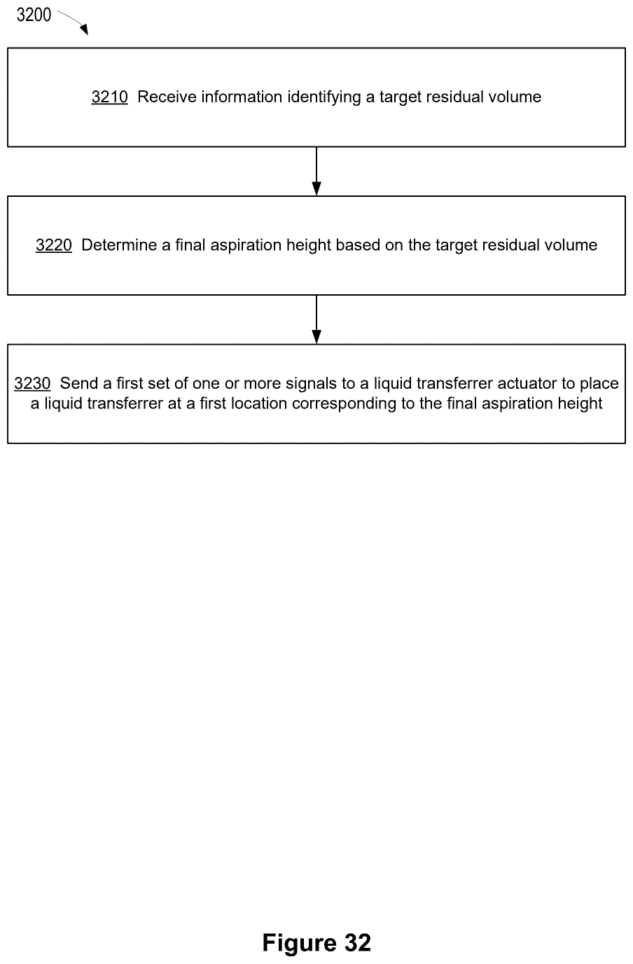

FIG. 32 is a flow diagram illustrating operations carried out by one or more processors of an electronic device for operating a liquid transferrer in accordance with some embodiments.

The one or more processors (3210) receiving information identifying a target residual volume; (3220) determine a final aspiration height based on the target residual volume; and (3230) send a first set of one or more signals to the liquid transferrer actuator to place the liquid transferrer at a first location corresponding to the final aspiration height.

In some embodiments, the liquid transferrer is located adjacent to a well; and placing the liquid transferrer at the first location causes a nozzle of the liquid transferrer to be located at the final aspiration height above a bottom of the well.

In some embodiments, the one or more processors, prior to sending the first set of one or more signals, send a second set of one or more signals to the liquid transferrer actuator to place the liquid transferrer at a second location corresponding to a height greater than the final aspiration height; and subsequent to sending the second set of one or more signals, send the first set of one or more signals to the liquid transferrer actuator to place the liquid transferrer at the first location.

In some embodiments, the one or more processors send the first set of one or more signals to the liquid transferrer actuator to place the liquid transferrer at the first location while the liquid transferrer aspirates liquid.

In some embodiments, the one or more processors determine an initial dispensing height based on the target residual volume; and send, subsequent to sending the first set of one or more signals to the liquid transferrer actuator, a third set of one or more signals to the liquid transferrer actuator to place the liquid transferrer at a third location corresponding to the initial dispensing height.

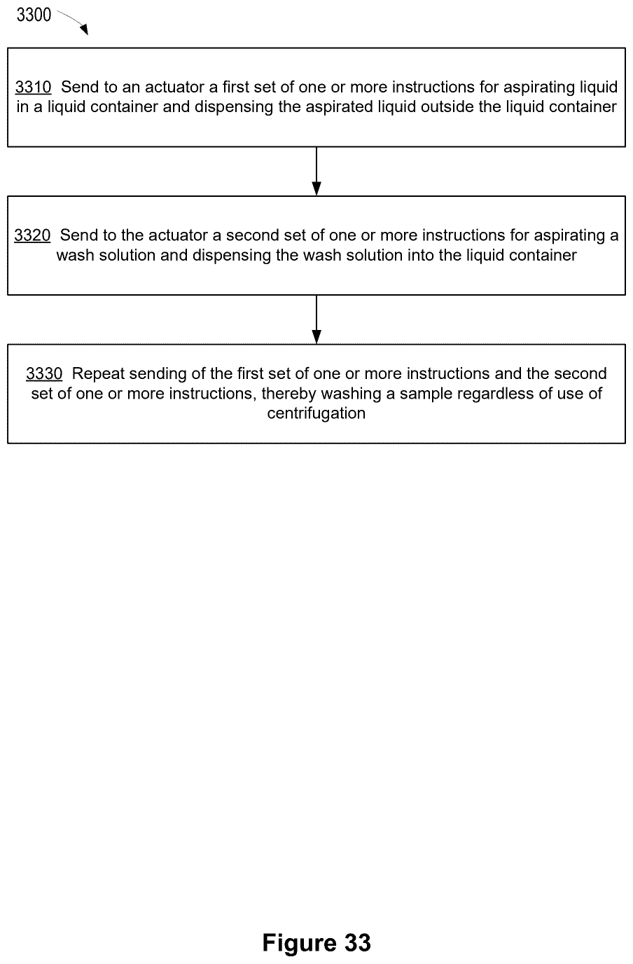

FIG. 33 is a flow diagram illustrating operations carried out by one or more processors for washing a sample in accordance with some embodiments.

The one or more processors (3310) send to the actuator a first set of one or more instructions for aspirating liquid in a liquid container and dispensing the aspirated liquid outside the liquid container; send to the actuator a second set of one or more instructions for aspirating a wash solution and dispensing the wash solution into the liquid container; and repeat sending of the first set of one or more instructions and the second set of one or more instructions, thereby washing a sample regardless of use of centrifugation.

In some embodiments, the one or more processors send the first set of one or more instructions to the actuator prior to sending the second set of one or more instructions to the actuator.

In some embodiments, the one or more processors send the first set of one or more instructions to the actuator subsequent to sending the second set of one or more instructions to the actuator.

In some embodiments, the one or more processors are in communication with a display. The one or more processors render a first user interface that includes a first user interface object for receiving a target residual volume.

In some embodiments, the first user interface includes a second user interface object for receiving a number of repeats for sending the first set of one or more instructions and the second set of one or more instructions.

In some embodiments, the first user interface includes one or more user interface objects for receiving one or more parameters for an incubation operation.

In some embodiments, the one or more user interface objects for receiving one or more parameters for an incubation operation includes a third user interface object for receiving a duration of incubation.

In some embodiments, the one or more user interface objects for receiving one or more parameters for an incubation operation includes a fourth user interface object for receiving an incubation temperature.

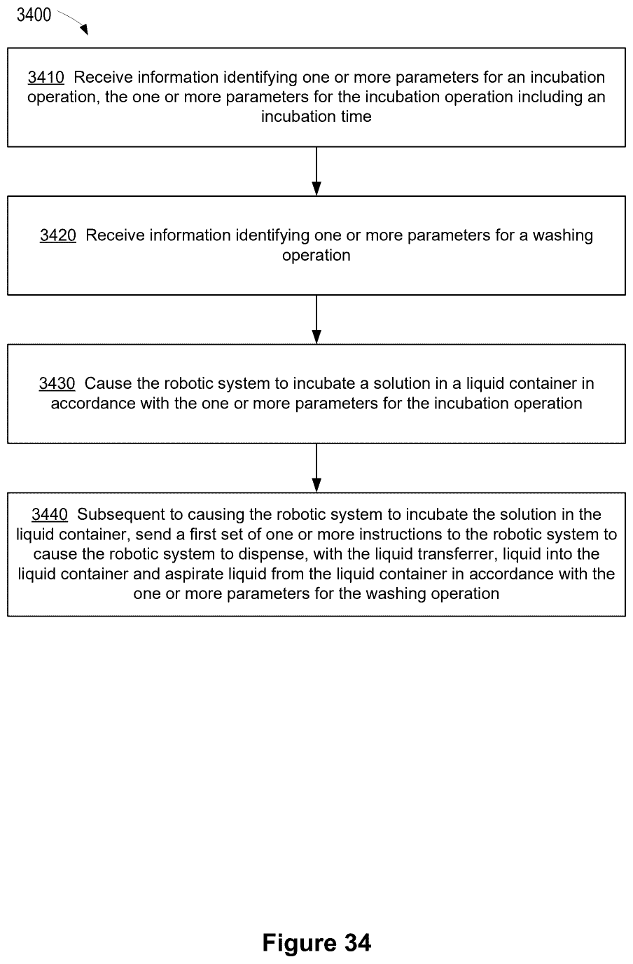

FIG. 34 is a flow diagram illustrating operations carried out by one or more processors for incubating a solution in accordance with some embodiments.

The one or more processors (3410) receive information identifying one or more parameters for an incubation operation, the one or more parameters for the incubation operation including an incubation time; (3420) receive information identifying one or more parameters for a washing operation; (3430) cause the robotic system to incubate a solution in a liquid container in accordance with the one or more parameters for the incubation operation; and (3440) subsequent to causing the robotic system to incubate the solution in the liquid container, send a first set of one or more instructions to the robotic system to cause the robotic system to dispense, with the liquid transferrer, liquid into the liquid container and aspirate liquid from the liquid container in accordance with the one or more parameters for the washing operation.

In some embodiments, causing the robotic system to incubate the solution in the liquid container includes foregoing sending one or more instructions for dispensing liquid into the liquid container or aspirating liquid from the liquid container.

In some embodiments, causing the robotic system to incubate the solution in the liquid container includes sending a second set of one or more instructions to the robotic system to the robotic system for causing the robotic system to incubate the solution in the liquid container.

In some embodiments, the second set of one or more instructions include one or more instructions for maintaining the liquid container at a predefined temperature in the one or more parameters for the incubation operation.

In some embodiments, the second set of one or more instructions include one or more instructions for moving the liquid transferrer to a predefined position.

In some embodiments, the one or more processors receive information identifying one or more parameters for a mixing operation.

In some embodiments, the one or more processors send to the robotic system a third set of one or more instructions for dispensing a reagent to the liquid container; and send to the robotic system a fourth set of one or more instructions for mixing liquid in the liquid container.

In some embodiments, the one or more processors send the third set of one or more instructions and the fourth set of one or more instructions prior to causing the robotic system to incubate the solution in the liquid container.

In some embodiments, sending to the robotic system the fourth set of one or more instructions for mixing the liquid in the liquid container includes sending the robotic system one or more instructions for stirring the liquid container with the liquid transferrer.

In some embodiments, sending to the robotic system the fourth set of one or more instructions for mixing the liquid in the liquid container includes sending the robotic system one or more instructions for aspirating at least a portion of the liquid container with the liquid transferrer and dispensing the aspirated portion of the liquid into the liquid container.

In some embodiments, the one or more processors position a pipette tip of the liquid transferrer immersed in the liquid in the liquid container during the aspirating operation and the dispensing operation.

In some embodiments, the one or more processors position the pipette tip of the liquid transferrer is positioned between 0.5 mm and 10 mm from a bottom of the liquid container.

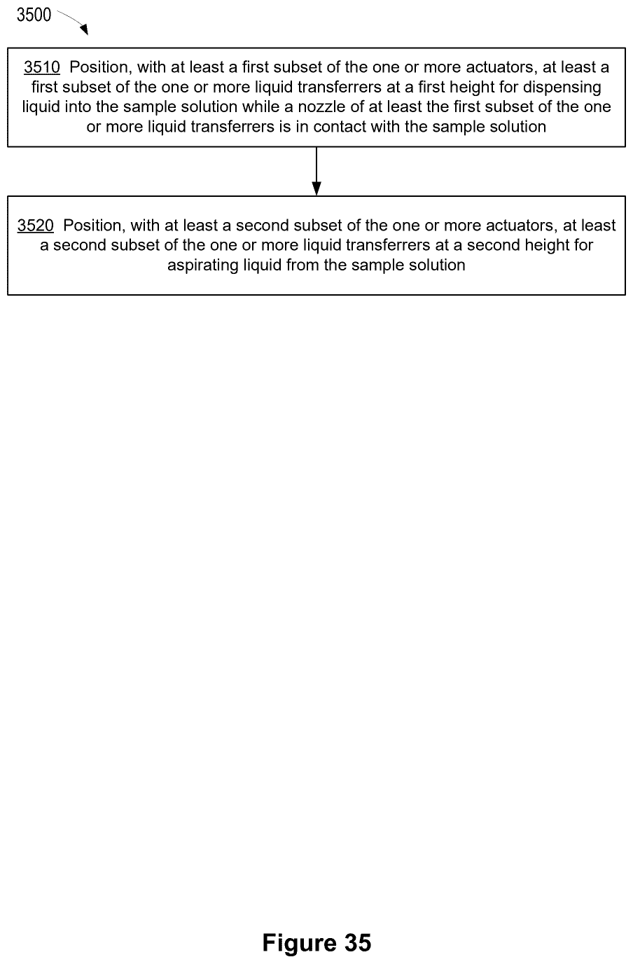

FIG. 35 is a flow diagram illustrating operations carried out by one or more processors for washing a sample in accordance with some embodiments.

The one or more processors (3510) position, with at least a first subset of the one or more actuators, at least a first subset of the one or more liquid transferrers at a first height for dispensing liquid into the sample solution while a nozzle of at least the first subset of the one or more liquid transferrers is in contact with the sample solution; and (3520) position, with at least a second subset of the one or more actuators, at least a second subset of the one or more liquid transferrers at a second height for aspirating liquid from the sample solution.

In some embodiments, the one or more processors position a first liquid transferrer at the first height for dispensing liquid into the sample solution from the first liquid transferrer; position the first liquid transferrer at the second height for aspirating liquid from the sample solution with the first liquid transferrer; and change the height of the first liquid transferrer during at least one of the dispensing or the aspirating.

In some embodiments, the one or more processors change the height of the first liquid transferrer during the dispensing; and change the height of the first liquid transferrer during the aspirating.

In some embodiments, the one or more processors change the height of the first liquid transferrer continuously during the dispensing.

In some embodiments, the one or more processors change the height of the first liquid transferrer step-wise during the dispensing.

In some embodiments, the one or more processors change the height of the first liquid transferrer continuously during the aspirating.

In some embodiments, the one or more processors change the height of the first liquid transferrer step-wise during the aspirating.

In some embodiments, the one or more processors change the height of the first liquid transferrer during the dispensing; and maintain the height of the first liquid transferrer during the aspirating.

In some embodiments, the one or more processors maintain the height of the first liquid transferrer during the dispensing; and change the height of the first liquid transferrer during the aspirating.

In some embodiments, the one or more liquid transferrers include a first dispenser and a first aspirator distinct and separate from the first dispenser. In some embodiments, the one or more processors position the first dispenser at the first height for dispensing liquid into the sample solution from the first liquid transferrer; position the first aspirator at the second height for aspirating liquid from the sample solution with the first liquid transferrer; and at least one of: changing the height of the first dispenser during the dispensing or changing the height of the first aspirator during the aspirating.

In some embodiments, the one or more processors change the height of the first dispenser during the dispensing; and change the height of the first aspirator during the aspirating.

In some embodiments, the one or more processors change the height of the first dispenser during the dispensing; and maintain the height of the first aspirator during the aspirating.

In some embodiments, the one or more processors maintain the height of the first dispenser during the dispensing; and change the height of the first aspirator during the aspirating.

In some embodiments, the first height is between 1 mm and 100 mm. In some embodiments, the first height is between 1 mm and 10 mm.

In some embodiments, the second height is between 1 mm and 100 mm. In some embodiments, the second height is between 1 mm and 10 mm.

In some embodiments, the first height is between 1.5 mm and 30 mm. In some embodiments, the first height is between 1.5 mm and 3 mm. In some embodiments, the second height is between 1.5 mm and 30 mm. In some embodiments, the second height is between 1.5 mm and 3 mm.

Various embodiments described herein may be combined. In addition, one or more operations described with one method may be included in another method. For brevity, such details are not repeated herein.

What is claimed is:

1. A computer readable storage medium storing one or more programs for execution by one or more processors of an electronic device in communication with an aspirator actuator coupled with an aspirator, the one or more programs including instructions for:
receiving information identifying a target residual volume;
determining a final aspiration height based on the target residual volume; and
sending a first set of one or more signals to the aspirator actuator to place the aspirator at a first location corresponding to the final aspiration height.

2. The computer readable storage medium of claim 1, wherein:
determining the final aspiration height includes identifying a height value from a lookup table using the target residual volume.

3. The computer readable storage medium of claim 1, wherein:
the one or more programs include instructions for receiving information identifying a type of a liquid container; and
determining the final aspiration height includes determining the final aspiration height based on the information identifying the type of the liquid container and the target residual volume.

4. The computer readable storage medium of claim 1, wherein:
the one or more programs include instructions for:
prior to sending the first set of one or more signals, sending a second set of one or more signals to the aspirator actuator to place the aspirator at a second location corresponding to a height greater than the final aspiration height; and
subsequent to sending the second set of one or more signals, sending the first set of one or more signals to the aspirator actuator to place the aspirator at the first location.

5. The computer readable storage medium of claim 4, wherein:
the one or more programs include instructions for sending the first set of one or more signals to the aspirator actuator to move the aspirator from the second location to the first location while the aspirator aspirates liquid.

6. The computer readable storage medium of claim 5, wherein:
the one or more programs include instructions for sending the first set of one or more signals to the aspirator actuator to move the aspirator from the second location to the first location at a speed selected based on an aspiration rate at which the aspirator aspirates liquid.

7. The computer readable storage medium of claim 4, wherein:
the one or more programs include instructions for sending the first set of one or more signals to the aspirator actuator to move the aspirator to the first location while the aspirator does not aspirate liquid.

8. The computer readable storage medium of claim 1, wherein:
the electronic device is in communication with a dispenser actuator coupled with a dispenser; and
the one or more programs include instructions for:
determining a first dispensing height based on the target residual volume; and
sending, subsequent to sending the first set of one or more signals to the aspirator actuator, a third set of one or more signals to the dispenser actuator to place the dispenser at a third location corresponding to the first dispensing height.

9. The computer readable storage medium of claim 8, wherein:
the one or more programs include instructions for sending, subsequent to sending the third set of one or more signals, a fourth set of one or more signals to the dispenser actuator to move the dispenser from the third location to a fourth location corresponding to a second dispensing height greater than the first dispensing height.

10. The computer readable storage medium of claim 9, wherein:
the one or more programs include instructions for sending the fourth set of one or more signals to the dispenser actuator to move the dispenser from the third location to the fourth location while the dispenser dispenses liquid.

11. The computer readable storage medium of claim 10, wherein:
the one or more programs include instructions for sending the fourth set of one or more signals to the dispenser actuator to move the dispenser from the third location to the fourth location at a speed selected based on a dispensing rate at which the dispenser dispenses liquid to maintain contact between the dispenser and liquid in a well.

12. The computer readable storage medium of claim 9, wherein:
the one or more programs include instructions for sending the fourth set of one or more signals to the dispenser actuator to move the dispenser to the fourth location while the dispenser does not dispense liquid.

13. The computer readable storage medium of claim 8, wherein:
the aspirator and the dispenser are fluidically coupled with a common nozzle.

14. A computer readable storage medium storing one or more programs for execution by one or more processors of an electronic device in communication with a dispenser actuator coupled with a dispenser, the one or more programs including instructions for:
receiving information identifying a target residual volume;
determining a first dispensing height based on the target residual volume; and
sending a first set of one or more signals to the dispenser actuator to place the dispenser at a first location corresponding to the first dispensing height.

15. The computer readable storage medium of claim 14, wherein:
determining the initial dispensing height includes identifying a height value from a lookup table using the target residual volume.

16. The computer readable storage medium of claim 14, wherein:
the one or more programs include instructions for receiving information identifying a type of a liquid container; and
determining the initial dispensing height includes determining the initial dispensing height based on the information identifying the type of the liquid container and the target residual volume.

17. The computer readable storage medium of claim 14, wherein:
the one or more programs include instructions for, subsequent to sending the first set of one or more signals, sending a second set of one or more signals to the dispenser actuator to place the dispenser at a second location corresponding to a height greater than the initial dispensing height.

18. The computer readable storage medium of claim 17, wherein:
the one or more programs include instructions for sending the second set of one or more signals to the dispenser actuator to move the dispenser from the first location to the second location while the dispenser dispenses liquid.

19. The computer readable storage medium of claim 14, wherein:
the electronic device is in communication with an aspirator actuator coupled with an aspirator;
determining a final aspiration height based on the target residual volume; and
the one or more programs include instructions for sending, subsequent to sending the first set of one or more signals to the dispenser actuator, a third set of one or more signals to the aspirator actuator to place the aspirator at a third location corresponding to the final aspiration height.

20. A computer readable storage medium storing one or more programs for execution by one or more processors of an electronic device in communication with a liquid transferrer actuator coupled with a liquid transferrer, the one or more programs including instructions for:
receiving information identifying a target residual volume;
determining a final aspiration height based on the target residual volume; and
sending a first set of one or more signals to the liquid transferrer actuator to place the liquid transferrer at a first location corresponding to the final aspiration height.
